(19) United States
(12) Patent Application Publication
(10) Pub. No.: US 2026/0197676 A1
(43) Pub. Date: Jul. 9, 2026

(54) WIRELESS COMMUNICATION METHOD SUPPORTING RELAY COMMUNICATION, AND WIRELESS COMMUNICATION TERMINAL USING SAME

(71) Applicant: WILUS INSTITUTE OF STANDARDS AND TECHNOLOGY INC., Gyeonggi-do (KR)

(72) Inventors: Sanghyun KIM, Gyeonggi-do (KR); Juhyung SON, Gyeonggi-do (KR); Geonjung KO, Gyeonggi-do (KR); Jinsam KWAK, Gyeonggi-do (KR)

(21) Appl. No.: 19/555,860

(22) Filed: Mar. 3, 2026

Related U.S. Application Data
(63) Continuation of application No. PCT/KR2024/012385, filed on Aug. 20, 2024.

(30) Foreign Application Priority Data
Sep. 4, 2023 (KR) 10-2023-0117260

(51) Int. Cl. H04W 24/02; H04B 17/318; H04W 88/04

(52) U.S. Cl. CPC H04W 24/02; H04B 17/318; H04W 88/04

(57) ABSTRACT

A second station relaying information exchange between a first station and a third station is disclosed. The second station comprises: a transceiver; and a processor, wherein the processor is configured to: transmit, to the third station, information on a critical update of the first station when an update corresponding to the critical update occurs in the first station.

### TECHNICAL FIELD

The disclosure relates to a wireless communication method supporting relay communication and a wireless communication terminal using the same.

### BACKGROUND ART

In recent years, with supply expansion of mobile apparatuses, a wireless LAN technology that can provide a rapid wireless s Internet service to the mobile apparatuses has been significantly spotlighted. The wireless LAN technology allows mobile apparatuses including a smart phone, a smart pad, a laptop computer, a portable multimedia player, an embedded apparatus, and the like to wirelessly access the Internet in home or a company or a specific service providing area based on a wireless communication technology in a short range.

Institute of Electrical and Electronics Engineers (IEEE) 802.11 has commercialized or developed various technological standards since an initial wireless LAN technology is supported using frequencies of 2.4 GHz. First, the IEEE 802.11b supports a communication speed of a maximum of 11 Mbps while using frequencies of a 2.4 GHz band. IEEE 802.11a which is commercialized after the IEEE 802.11b uses frequencies of not the 2.4 GHz band but a 5 GHz band to reduce an influence by interference as compared with the frequencies of the 2.4 GHz band which are significantly congested and improves the communication speed up to a maximum of 54 Mbps by using an OFDM technology. However, the IEEE 802.11a has a disadvantage in that a communication distance is shorter than the IEEE 802.11b. In addition, IEEE 802.11g uses the frequencies of the 2.4 GHz band similarly to the IEEE 802.11b to implement the communication speed of a maximum of 54 Mbps and satisfies backward compatibility to significantly come into the spotlight and further, is superior to the IEEE 802.11a in terms of the communication distance.

Moreover, as a technology standard established to overcome a limitation of the communication speed which is pointed out as a weak point in a wireless LAN, IEEE 802.11n has been provided. The IEEE 802.11n aims at increasing the speed and reliability of a network and extending an operating distance of a wireless network. In more detail, the IEEE 802.11n supports a high throughput (HT) in which a data processing speed is a maximum of 540 Mbps or more and further, is based on a multiple inputs and multiple outputs (MIMO) technology in which multiple antennas are used at both sides of a transmitting unit and a receiving unit in order to minimize a transmission error and optimize a data speed. Further, the standard can use a coding scheme that transmits multiple copies which overlap with each other in order to increase data reliability.

As the supply of the wireless LAN is activated and further, applications using the wireless LAN are diversified, the need for new wireless LAN systems for supporting a higher throughput (very high throughput (VHT)) than the data processing speed supported by the IEEE 802.11n has come into the spotlight. Among them, IEEE 802.11ac supports a wide bandwidth (80 to 160 MHz) in the 5 GHz frequencies. The IEEE 802.11ac standard is defined only in the 5 GHz band, but initial 11ac chipsets will support even operations in the 2.4 GHz band for the backward compatibility with the existing 2.4 GHz band products. Theoretically, according to the standard, wireless LAN speeds of multiple stations are enabled up to a minimum of 1 Gbps and a maximum single link speed is enabled up to a minimum of 500 Mbps. This is achieved by extending concepts of a wireless interface accepted by 802.11n, such as a wider wireless frequency bandwidth (a maximum of 160 MHz), more MIMO spatial streams (a maximum of 8), multi-user MIMO, and high-density modulation (a maximum of 256 QAM). Further, as a scheme that transmits data by using a 60 GHz band instead of the existing 2.4 GHZ/5 GHZ, IEEE 802.11ad has been provided. The IEEE 802.11ad is a transmission standard that provides a speed of a maximum of 7 Gbps by using a beamforming technology and is suitable for high bit rate moving picture streaming such as massive data or non-compression HD video. However, since it is difficult for the 60 GHz frequency band to pass through an obstacle, it is disadvantageous in that the 60 GHz frequency band can be used only among devices in a short-distance space.

As a wireless LAN standard after 802.11ac and 802.11ad, the IEEE 802.11ax (high efficiency WLAN, HEW) standard for providing a high-efficiency and high-performance wireless LAN communication technology in a high-density environment, in which APs and terminals are concentrated, is in the development completion stage. In an 802.11ax-based wireless LAN environment, communication with high frequency efficiency should be provided indoors/outdoors in the presence of high-density stations and access points (APs), and various technologies have been developed to implement the same.

In order to support new multimedia applications, such as high-definition video and real-time games, the development of a new wireless LAN standard has begun to increase a maximum transmission rate. In IEEE 802.11be (extremely high throughput, EHT), which is a 7th generation wireless LAN standard, development of standards is underway aiming at supporting a transmission rate of up to 30 Gbps via a wider bandwidth, an increased spatial stream, multi-AP cooperation, and the like in a 2.4/5/6 GHz band

Recently, discussions have begun on ultra-high reliability (UHR) wireless LAN communication technology as a wireless LAN standard following 802.11be, in order to overcome the reliability issue that has been pointed out as a limit of wireless LANs. The UHR wireless LAN standard is under development with the goal of supporting low latency and low jitter in wireless LAN traffic with a high probability (e.g., 99.9999% or higher).

### DISCLOSURE OF INVENTION

### Technical Problem

An embodiment of the disclosure is directed to providing a wireless communication method supporting relay communication and a wireless communication terminal using the same.

### Solution to Problem

According to an embodiment of the disclosure, a non-AP station communicating with an access point (AP) includes a transceiver and a processor. The processor receives a downlink relay MPDU including traffic for a destination station from the AP and transmits the downlink relay MPDU to the destination station.

The processor, when the non-AP station performs a power-save operation, may not receive the downlink relay MPDU during periods other than the non-AP station's target wakeup time (TWT) service period (SP) and may not transmit the downlink relay MPDU to the destination station.

The non-AP station's TWT SP may be included in the destination station's TWT SP.

The processor may transmit, to an AP, information on the capability related to a relay operation of the non-AP station. The information on the capability related to the relay operation of the non-AP station may include information on a relay service period indicating a period in which the non-AP station is capable of performing a relay operation.

The information on the capability related to the relay operation may further include information on the maximum frequency bandwidth supported when the non-AP station transmits/receives for the relay operation.

The information on the capability related to the relay operation may further include information on the maximum transmission output usable when the non-AP STA transmits a PPDU for the relay operation.

The processor may measure a reception sensitivity of a measurement frame received from the destination station and transmit, to the AP, a reporting frame including information on the reception sensitivity of the measurement frame.

The reporting frame may include information on the reception sensitivity of a request frame triggering transmission of the measurement frame.

The processor may receive an uplink relay MPDU including traffic for the AP from the destination station and transmit the uplink relay MPDU to the AP.

The processor may receive an uplink relay MPDU from the destination station within a transmission opportunity (TXOP) allocated to the non-AP station by the destination station and transmit the uplink relay MPDU to the AP.

A first request to send (RTS) frame may be received from the AP before transmitting the downlink relay MPDU and a first clear to send (CTS) frame may be transmitted to the AP in response to the first RTS frame. The AP and the destination station may exchange a second RTS frame and a second CTS frame before transmitting the downlink relay MPDU.

According to an embodiment of the disclosure, an access point (AP) communicating with a non-AP station includes a transceiver and a processor.

The processor may transmit, to a relay station, a downlink relay MPDU including traffic for a destination station.

The relay station, when performing a power-save operation, may not receive the downlink relay MPDU during periods other than the relay station's target wakeup time (TWT) service period (SP) and may not transmit the downlink relay MPDU to the destination station. The processor, when the relay station performs a power-save operation, may not transmit the downlink relay MPDU to the relay station during periods other than the TWT service period.

The processor may receive, from the relay station, information on the capability related to a relay operation of the relay station and determine whether to perform a relay operation with the relay station based on information on the capability related to the relay operation. The information on the capability related to the relay operation may include information on a relay service period indicating a period in which the non-AP station is capable of performing a relay operation.

The information on the capability related to the relay operation may further include information on the maximum frequency bandwidth supported when the non-AP station transmits/receives for the relay operation.

The information on the capability related to the relay operation may further include information on the maximum transmission output usable when the non-AP STA transmits a PPDU for the relay operation.

The processor may transmit a frame triggering a measurement frame transmission of the destination station and receive, from the relay station, a reporting frame including information on the reception sensitivity of the measurement frame.

The reporting frame may include information on the reception sensitivity of a request frame triggering transmission of the measurement frame.

A first request to send (RTS) frame may be transmitted to the relay station before transmitting the downlink relay MPDU, a first clear to send (CTS) frame may be received from the relay station in response to the first RTS frame, a second RTS frame may be transmitted to the destination station before transmitting the downlink relay MPDU, and a second CTS frame may be received from the destination station in response to the second RTS frame.

According to an embodiment of the disclosure, a non-AP station communicating with an access point (AP) includes a transceiver and a processor. The processor transmits, to a relay station, an uplink relay MPDU including traffic for an AP.

The relay station, when performing a power-save operation, may not receive the uplink relay MPDU during periods other than the relay station's target wakeup time (TWT) service period (SP) and may not transmit the uplink relay MPDU to the AP. The processor, when the relay station performs a power-save operation, may not transmit the uplink relay MPDU to the relay station during periods other than the TWT service period. The TWT SP of the relay station is included in the TWT SP of the non-AP station.

The processor may receive a frame triggering a measurement frame transmission of the destination station and transmit a measurement frame in response to the trigger frame.

The processor may transmit a first request to send (RTS) frame to the relay station before transmitting the uplink relay MPDU, receive a first clear to send (CTS) frame from the relay station in response to the first RTS frame, transmit a second RTS frame to the AP before transmitting the uplink relay MPDU, and receive a second CTS frame from the AP in response to the second RTS frame.

According to an embodiment of the disclosure, an operation method performed by a non-AP station communicating with an access point (AP) includes receiving a downlink relay MPDU including traffic for a destination station from the AP and transmitting the downlink relay MPDU to the destination station.

According to an embodiment of the disclosure, an operation method performed by an access point (AP) communicating with a non-AP station includes transmitting, to a relay station, a downlink relay MPDU including traffic for a destination station.

According to an embodiment of the disclosure, an operation method performed by a non-AP station communicating with an access point (AP) includes transmitting, to a relay station, an uplink relay MPDU including traffic for an AP.

### Advantageous Effects of Invention

An embodiment of the disclosure provides a wireless communication method efficiently supporting relay communication and a wireless communication terminal using the same.

### BRIEF DESCRIPTION OF DRAWINGS

FIG. 1 illustrates a wireless LAN system according to an embodiment of the present invention.

FIG. 2 illustrates a wireless LAN system according to another embodiment of the present invention.

FIG. 3 illustrates a configuration of a station according to an embodiment of the present invention.

FIG. 4 illustrates a configuration of an access point according to an embodiment of the present invention.

FIG. 5 schematically illustrates a process in which a STA and an AP set a link.

FIG. 6 illustrates a carrier sense multiple access (CSMA)/collision avoidance (CA) method used in wireless LAN communication.

FIG. 7 illustrates physical layer protocol data unit (PPDU) formats of various standard generations according to an embodiment of the present disclosure.

FIG. 8 illustrates an EHT/UHR PPDU format according to an embodiment of the present disclosure.

FIG. 9 illustrates a transmission/TXOP protection method using an RTS frame and a CTS frame according to an embodiment of the present disclosure.

FIG. 10 illustrates a transmission/TXOP protection method using an MU-RTS frame and a CTS frame according to an embodiment of the present disclosure.

FIG. 11 illustrates a format of a trigger frame according to an embodiment of the disclosure.

FIG. 12 illustrates a format of a Common Info field of a trigger frame according to an embodiment of the disclosure.

FIG. 13 illustrates a format of a User Info field of a trigger frame according to an embodiment of the disclosure.

FIG. 14 illustrates a network including a relay station according to an embodiment of the disclosure.

FIG. 15 illustrates an MPDU and ACK exchange procedure using a relay station according to an embodiment of the disclosure.

FIG. 16 illustrates a non-AP station searching for a non-AP station operating as a relay station according to an embodiment of the disclosure.

FIG. 17 illustrates that relay setup is completed and a destination station and a relay station operate in a relay operation according to an embodiment of the disclosure.

FIG. 18 illustrates a format of a frame exchanged in a relay setup process according to an embodiment of the disclosure.

FIG. 19 illustrates performing a relay operation within a TXOP allocated by an AP according to an embodiment of the disclosure.

FIG. 20 illustrates an AP allocating an RU to a relay station and the relay station performing a relay operation in the allocated RU according to an embodiment of the disclosure.

FIG. 21 illustrates an SR operation performed in an RU allocated to a relay station by an AP according to an embodiment of the disclosure.

FIG. 22 illustrates an operation of a relay station transmitting a relay PPDU for multiple destination stations according to an embodiment of the disclosure.

FIG. 23 illustrates an operation of transmitting a relay PPDU including both an MPDU transmitted by a relay station to an AP and an MPDU transmitted by the relay station to a destination station according to an embodiment of the disclosure.

FIG. 24 illustrates that when a relay station transmits a UL PPDU to transmit an MPDU received from a destination station, the UL PPDU includes an MPDU transmitted by the relay station to an AP according to an embodiment of the disclosure.

FIG. 25 illustrates a format of a UL PPDU including an MPDU received by a relay station from a destination station and an MPDU transmitted by the relay station to an AP according to an embodiment of the disclosure.

FIG. 26 illustrates the format of a generally used BlockAck frame.

FIG. 27 illustrates a format of a general multi-STA BlockAck frame.

FIG. 28 illustrates a format of a Multi-STA BlockAck frame transmitted by a relay station according to an embodiment of the disclosure.

FIG. 29 illustrates an operation in which an AP performs two times of RTS frame/CTS frame exchanges to protect relay downlink transmission according to an embodiment of the disclosure.

FIG. 30 illustrates an operation in which an AP performs one time of RTS frame/CTS frame exchange to protect relay downlink transmission according to an embodiment of the disclosure.

FIG. 31 illustrates an operation in which a non-AP station performs two times of RTS frame/CTS frame exchanges to protect uplink transmission relay according to an embodiment of the disclosure.

FIG. 32 illustrates an operation of an AP designating a relay station for a destination station according to an embodiment of the disclosure.

FIG. 33 illustrates an operation in which a TWT agreement established between a relay station and an AP is applied to a destination station according to an embodiment of the disclosure.

FIG. 34 illustrates a Relay Support element according to an embodiment of the disclosure.

FIG. 35 illustrates a relay operation performed based on a relay service period indicated by a relay station according to an embodiment of the disclosure.

### MODE FOR CARRYING OUT THE INVENTION

Terms used in the specification adopt general terms which are currently widely used by considering functions in the present invention, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

Throughout this specification and the claims that follow, when it is described that an element is “coupled” to another element, the element may be “directly coupled” to the other element or “electrically coupled” to the other element through a third element. Further, unless explicitly described to the contrary, the word “comprise” and variations such as “comprises” or “comprising”, will be understood to imply the inclusion of stated elements but not the exclusion of any other elements. Moreover, limitations such as “or more” or “or less” based on a specific threshold may be appropriately substituted with “more than” or “less than”, respectively.

Hereinafter, in the present invention, a field and a subfield may be interchangeably used.

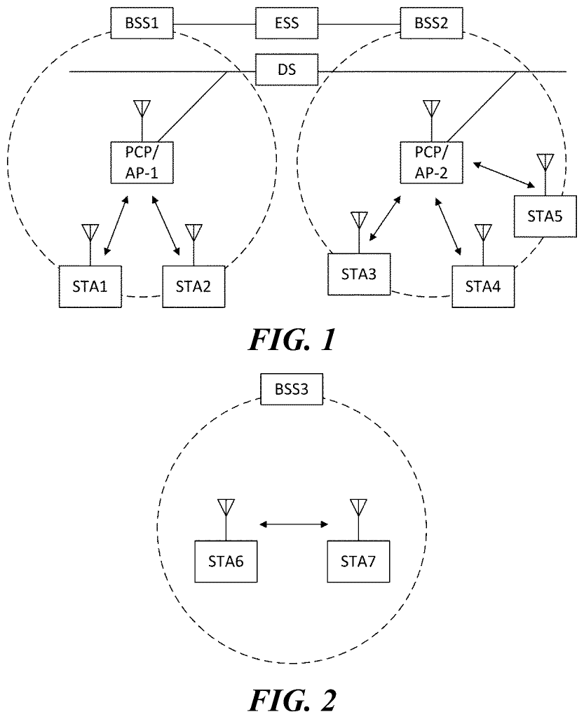

FIG. 1 illustrates a wireless LAN system according to an embodiment of the present invention.

FIG. 1 is a diagram illustrating a wireless LAN system according to an embodiment of the present invention. The wireless LAN system includes one or more basic service sets (BSS) and the BSS represents a set of apparatuses which are successfully synchronized with each other to communicate with each other. In general, the BSS may be classified into an infrastructure BSS and an independent BSS (IBSS) and FIG. 1 illustrates the infrastructure BSS between them.

As illustrated in FIG. 1, the infrastructure BSS (BSS1 and BSS2) includes one or more stations STA1, STA2, STA3, STA4, and STA5, access points AP-1 and AP-2 which are stations providing a distribution service, and a distribution system (DS) connecting the multiple access points AP-1 and AP-2.

The station (STA) is a predetermined device including medium access control (MAC) following a regulation of an IEEE 802.11 standard and a physical layer interface for a wireless medium, and includes both a non-access point (non-AP) station and an access point (AP) in a broad sense. Further, in the present specification, a term ‘terminal’ may be used to refer to a non-AP STA, or an AP, or to both terms. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally connected with the processor and transmits and receives frames through the wireless network for the station. According to the present invention, a terminal may be used as a term which includes user equipment (UE).

The access point (AP) is an entity that provides access to the distribution system (DS) via wireless medium for the station associated therewith. In the infrastructure BSS, communication among non-AP stations is, in principle, performed via the AP, but when a direct link is configured, direct communication is enabled even among the non-AP stations. Meanwhile, in the present invention, the AP is used as a concept including a personal BSS coordination point (PCP) and may include concepts including a centralized controller, a base station (BS), a node-B, a base transceiver system (BTS), and a site controller in a broad sense. In the present invention, an AP may also be referred to as a base wireless communication terminal. The base wireless communication terminal may be used as a term which includes an AP, a base station, an eNB (i.e. eNodeB) and a transmission point (TP) in a broad sense. In addition, the base wireless communication terminal may include various types of wireless communication terminals that allocate medium resources and perform scheduling in communication with a plurality of wireless communication terminals.

A plurality of infrastructure BSSs may be connected with each other through the distribution system (DS). In this case, a plurality of BSSs connected through the distribution system is referred to as an extended service set (ESS).

FIG. 2 illustrates an independent BSS which is a wireless LAN system according to another embodiment of the present invention. In the embodiment of FIG. 2, duplicative description of parts, which are the same as or correspond to the embodiment of FIG. 1, will be omitted.

Since a BSS3 illustrated in FIG. 2 is the independent BSS and does not include the AP, all stations STA6 and STA7 are not connected with the AP. The independent BSS is not permitted to access the distribution system and forms a self-contained network. In the independent BSS, the respective stations STA6 and STA7 may be directly connected with each other.

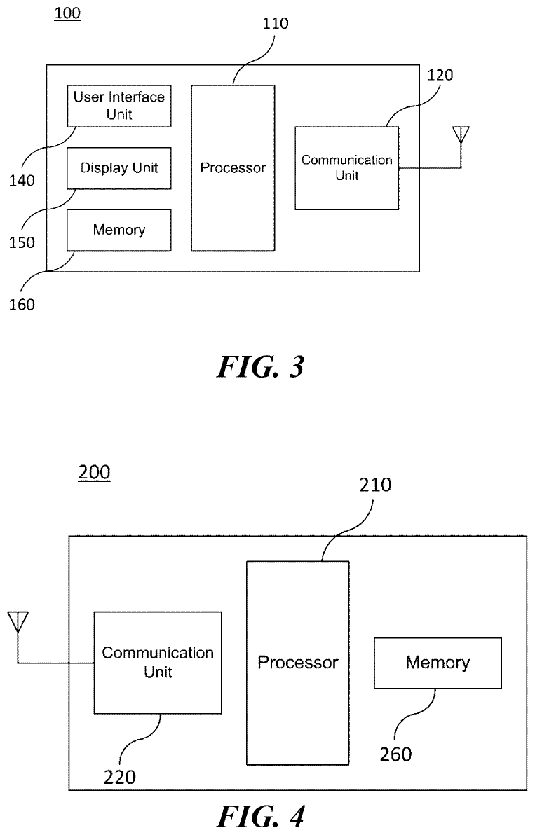

FIG. 3 is a block diagram illustrating a configuration of a station 100 according to an embodiment of the present invention. As illustrated in FIG. 3, the station 100 according to the embodiment of the present invention may include a processor 110, a communication unit 120, a user interface unit 140, a display unit 150, and a memory 160.

First, the communication unit 120 transmits and receives a wireless signal such as a wireless LAN packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHZ, 5 GHZ, 6 GHZ and 60 GHZ. According to an embodiment, the station 100 may include a communication module using a frequency band of 7.125 GHz or more and a communication module using a frequency band of 7.125 GHz or less. The respective communication modules may perform wireless communication with the AP or an external station according to a wireless LAN standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present invention, the communication unit 120 may represent a radio frequency (RF) communication module for processing an RF signal.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like. Further, the memory 160 stores a control program used in the station 100 and various resulting data. The control program may include an access program required for the station 100 to access the AP or the external station.

The processor 110 of the present invention may execute various commands or programs and process data in the station 100. Further, the processor 110 may control the respective units of the station 100 and control data transmission/reception among the units. According to the embodiment of the present invention, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 of the present invention may represent a main control unit of the station 100 and according to the embodiment, the processor 110 may represent a control unit for individually controlling some component of the station 100, for example, the communication unit 120, and the like. That is, the processor 110 may be a modem or a modulator/demodulator for modulating and demodulating wireless signals transmitted to and received from the communication unit 120. The processor 110 controls various operations of wireless signal transmission/reception of the station 100 according to the embodiment of the present invention. A detailed embodiment thereof will be described below.

The station 100 illustrated in FIG. 3 is a block diagram according to an embodiment of the present invention, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present invention, some components of the station 100, for example, the user interface unit 140 and the display unit 150 may be optionally provided in the station 100.

FIG. 4 is a block diagram illustrating a configuration of an AP 200 according to an embodiment of the present invention. As illustrated in FIG. 4, the AP 200 according to the embodiment of the present invention may include a processor 210, a communication unit 220, and a memory 260. In FIG. 4, among the components of the AP 200, duplicative description of parts which are the same as or correspond to the components of the station 100 of FIG. 2 will be omitted.

Referring to FIG. 4, the AP 200 according to the present invention includes the communication unit 220 for operating the BSS in at least one frequency band. As described in the embodiment of FIG. 3, the communication unit 220 of the AP 200 may also include a plurality of communication modules using different frequency bands. That is, the AP 200 according to the embodiment of the present invention may include two or more communication modules among different frequency bands, for example, 2.4 GHZ, 5 GHZ, 6 GHZ and 60 GHz together. Preferably, the AP 200 may include a communication module using a frequency band of 7.125 GHz or more and a communication module using a frequency band of 7.125 GHz or less. The respective communication modules may perform wireless communication with the station according to a wireless LAN standard of a frequency band supported by the corresponding communication module. The communication unit 220 may operate only one communication module at a time or simultaneously operate multiple communication modules together according to the performance and requirements of the AP 200. In an embodiment of the present invention, the communication unit 220 may represent a radio frequency (RF) communication module for processing an RF signal.

Next, the memory 260 stores a control program used in the AP 200 and various resulting data. The control program may include an access program for managing the access of the station. Further, the processor 210 may control the respective units of the AP 200 and control data transmission/reception among the units. According to the embodiment of the present invention, the processor 210 may execute the program for accessing the station stored in the memory 260 and transmit communication configuration messages for one or more stations. In this case, the communication configuration messages may include information about access priority conditions of the respective stations. Further, the processor 210 performs an access configuration according to an access request of the station. According to an embodiment, the processor 210 may be a modem or a modulator/demodulator for modulating and demodulating wireless signals transmitted to and received from the communication unit 220. The processor 210 controls various operations such as wireless signal transmission/reception of the AP 200 according to the embodiment of the present invention. A detailed embodiment thereof will be described below.

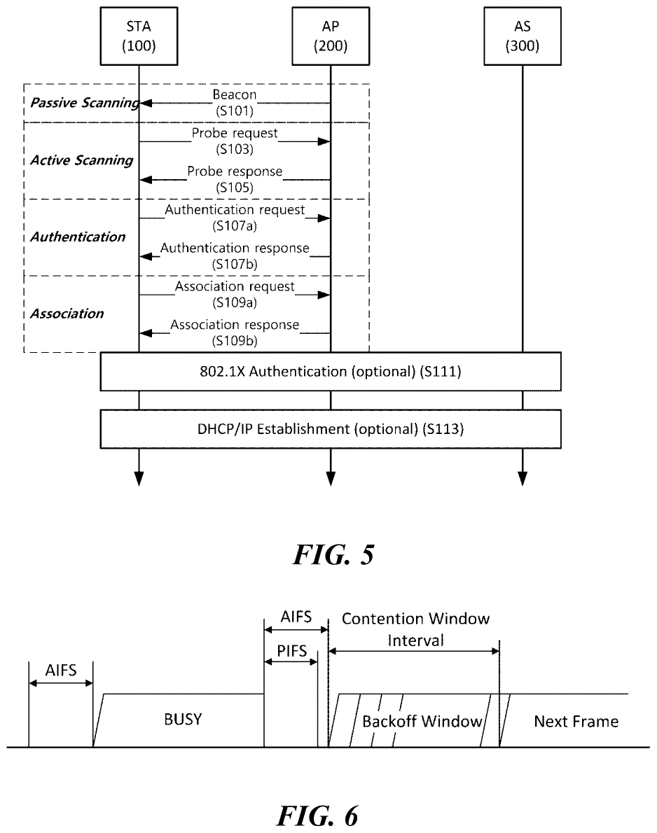

FIG. 5 is a diagram schematically illustrating a process in which a STA sets a link with an AP.

Referring to FIG. 5, the link between the STA 100 and the AP 200 is set through three steps of scanning, authentication, and association in a broad way. First, the scanning step is a step in which the STA 100 obtains access information of BSS operated by the AP 200. A method for performing the scanning includes a passive scanning method in which the AP 200 obtains information by using a beacon message (S101) which is periodically transmitted and an active scanning method in which the STA 100 transmits a probe request to the AP (S103) and obtains access information by receiving a probe response from the AP (S105).

The STA 100 that successfully receives wireless access information in the scanning step performs the authentication step by transmitting an authentication request (S107a) and receiving an authentication response from the AP 200 (S107b). After the authentication step is performed, the STA 100 performs the association step by transmitting an association request (S109a) and receiving an association response from the AP 200 (S109b). In this specification, an association basically means a wireless association, but the present invention is not limited thereto, and the association may include both the wireless association and a wired association in a broad sense.

Meanwhile, an 802.1X based authentication step (S111) and an IP address obtaining step (S113) through DHCP may be additionally performed. In FIG. 5, the authentication server 300 is a server that processes 802.1X based authentication with the STA 100 and may be present in physical association with the AP 200 or present as a separate server.

FIG. 6 is a diagram illustrating a carrier sense multiple access (CSMA)/collision avoidance (CA) method used in wireless LAN communication.

A terminal that performs a wireless LAN communication checks whether a channel is busy by performing carrier sensing before transmitting data. When a wireless signal having a predetermined strength or more is sensed, it is determined that the corresponding channel is busy and the terminal delays the access to the corresponding channel. Such a process is referred to as clear channel assessment (CCA) and a level to decide whether the corresponding signal is sensed is referred to as a CCA threshold. When a wireless signal having the CCA threshold or more, which is received by the terminal, indicates the corresponding terminal as a receiver, the terminal processes the received wireless signal. Meanwhile, when a wireless signal is not sensed in the corresponding channel or a wireless signal having a strength smaller than the CCA threshold is sensed, it is determined that the channel is idle.

When it is determined that the channel is idle, each terminal having data to be transmitted performs a backoff procedure after an inter frame space (IFS) time depending on a situation of each terminal, for instance, an arbitration IFS (AIFS), a PCF IFS (PIFS), or the like elapses. According to the embodiment, the AIFS may be used as a component which substitutes for the existing DCF IFS (DIFS). Each terminal stands by while decreasing slot time(s) as long as a random number determined by the corresponding terminal during an interval of an idle state of the channel and a terminal that completely exhausts the slot time(s) attempts to access the corresponding channel. As such, an interval in which each terminal performs the backoff procedure is referred to as a contention window interval. In this case, the random number may be referred to as a backoff counter. That is, an initial value of the backoff counter is configured by an integer corresponding to a random number acquired by the terminal. When the terminal detects that the channel is idle during a slot time, the terminal may reduce the backoff counter by 1. In addition, when the backoff counter reaches 0, the terminal may be allowed to perform channel access in the corresponding channel. Accordingly, when the channel is idle for a slot time of the backoff counter or an AIFS time, transmission of the terminal may be allowed.

When a specific terminal successfully accesses the channel, the corresponding terminal may transmit data through the channel. However, when the terminal which attempts the access collides with another terminal, the terminals which collide with each other are assigned with new random numbers, respectively to perform the backoff procedure again. According to an embodiment, a random number newly assigned to each terminal may be decided within a range (2*CW) which is twice larger than a range (a contention window, CW) of a random number which the corresponding terminal is previously assigned. Meanwhile, each terminal attempts the access by performing the backoff procedure again in a next contention window interval and in this case, each terminal performs the backoff procedure from slot time(s) which remained in the previous contention window interval. By such a method, the respective terminals that perform the wireless LAN communication may avoid a mutual collision for a specific channel.

### <Examples of Various PPDU Formats>

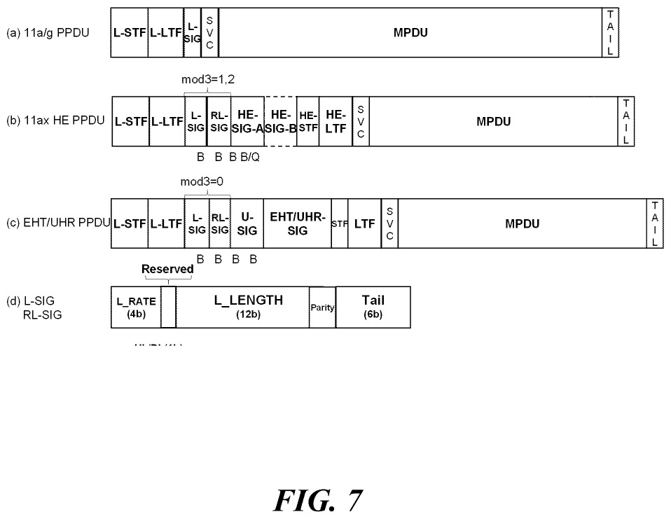

FIG. 7 illustrates physical layer protocol data unit (PPDU) formats of various standard generations according to an embodiment of the present disclosure.

More specifically, (a) of FIG. 7 illustrates an embodiment of a legacy PPDU format based on 802.11a/g, (b) of FIG. 7 illustrates an embodiment of an HE PPDU format based on 802.11ax, and FIG. 7C illustrates an embodiment of a non-legacy PPDU (i.e., EHT PPDU) format based on 802.11be. Furthermore, (d) of FIG. 7 illustrates a detailed field configuration of an L-SIG and an RL-SIG commonly used in the PPDU formats.

Referring to (a) of FIG. 7, a preamble of the legacy PPDU includes a legacy short training field (L-STF), a legacy long training field (L-LTF), and a legacy signal field (L-SIG). In an embodiment of the present invention, the L-STF, the L-LTF, and the L-SIG may be referred to as a legacy preamble.

Referring to (b) of FIG. 7, a preamble of the HE PPDU additionally includes, in the legacy preamble, a repeated legacy short training field (RL-SIG), a high efficiency signal A field (HE-SIG-A), a high efficiency signal B field (HE-SIG-B), a high efficiency short training field (HE-STF), and a high efficiency long training field (HE-LTF). In an embodiment of the present invention, the RL-SIG, HE-SIG-A, the HE-SIG-B, the HE-STF and the HE-LTF may be referred to as an HE preamble. A specific configuration of the HE preamble may be modified according to an HE PPDU format. For example, HE-SIG-B may be used only in an HE MU PPDU format.

Referring to (c) of FIG. 7, a preamble of the EHT PPDU additionally includes, in the legacy preamble, a repeated legacy short training field (RL-SIG), a universal signal field (U-SIG), and an extremely high throughput signal A field (EHT-SIG-A), an extremely high throughput signal B field (EHT-SIG-B), an extremely high throughput short training field (EHT-STF), and an extremely high throughput long training field (EHT-LTF). In an embodiment of the present invention, the RL-SIG, EHT-SIG-A, the EHT-SIG-B, the EHT-STF and the EHT-LTF may be referred to as an EHT preamble. A specific configuration of a non-legacy preamble may be modified according to an EHT PPDU format. For example, EHT-SIG-A and EHT-SIG-B may be used only in a part of the EHT PPDU format.

As such, the PPDU used in the UHR standard may have a format similar to that of the PPDU used in the EHT standard. This is because the EHT PPDU format defined in 802.11be includes a U-SIG field that has been agreed to be commonly used by a plurality of wireless LAN generations. In this case, the value of the PHY Version Identifier field of the U-SIG field included in the EHT PPDU may be 0, and the value of the PHY Version identifier field of the U-SIG field included in the UHR PPDU may be 1, which is a value other than 0. The EHT PPDU includes an extremely high throughput short training field (EHT-STF) in the STF field, and includes an extremely high throughput long training field (EHT-LTF) in the LTF field. The UHR PPDU includes a UHR-STF (Ultra High Reliability Short Training field) in the STF field, and includes a UHR-LTF (Ultra High Reliability Long Training field) in the LTF field.

64-FFT OFDM is applied in an L-SIG field included in the preamble of the PPDU, and the L-SIG field includes a total of 64 subcarriers. Among 64 subcarriers, 48 subcarriers excluding a guard subcarrier, a DC subcarrier, and a pilot subcarrier are used for transmission of L-SIG data. BPSK and a modulation and coding scheme (MCS) of rate=1/2 are applied in L-SIG, and therefore the L-SIG may include a total of 24 bits of information. FIG. 7(d) illustrates a 24-bit information configuration of L-SIG.

Referring to (d) of FIG. 7, the L-SIG includes an L_RATE field and an L_LENGTH field. The L_RATE field includes 4 bits and indicates an MCS used for data transmission. Specifically, the L_RATE field indicates one value among transmission rates of Jun. 9, 2012/18/24/36/48/54 Mbps obtained by combining a modulation scheme of BPSK/QPSK/16-QAM/64-QAM, etc. and an inefficiency of 1/2, 2/3, 3/4, etc. A total length of a corresponding PPDU may be indicated by combining information of the L_RATE field and information of the L_LENGTH field. In a non-legacy PPDU format, the L_RATE field is configured to a minimum rate of 6 Mbps.

A unit of the L_LENGTH field is a byte and a total of 12 bits are allocated to signal up to 4095, and a length of the PPDU may be indicated in combination with the L_RATE field. A legacy terminal and a non-legacy terminal may interpret the L_LENGTH field in different ways.

Firstly, a method of interpreting the length of the PPDU by the legacy terminal and the non-legacy terminal by using the L_LENGTH field is described below. When a value of the L_RATE field is configured to indicate 6 Mbps, 3 bytes during 4 μs which is one symbol duration of 64 FET (i.e., 24 bits) may be transmitted. Therefore, the 64 FET standard symbol number after an L-SIG is acquired by adding 3 bytes corresponding to a SVC field and a Tail field to the L_LENGTH field value and then dividing the same by 3 bytes which is a transmission amount of one symbol. When multiplying the acquired symbol number by 4 μs which is one symbol duration and then adding 20 μs which is consumed to transmit the L-STF, the L-LTF, and the L-SIG, the length of a corresponding PPDU, i.e., a receipt time (RXTIME) is acquired, which is expressed by Equation 1 below.

$$RXTIME ( us ) = ( ⌈ \frac{L\_LENGTH + 3}{3} ⌉ ) \times 4 + 20 \qquad [ Equation 1 ]$$

In this case, ┌x┐ denotes the smallest natural number greater than or equal to x. Since the maximum value of the L_LENGTH field is 4095, the length of the PPDU can be set up to 5.464 ms. The non-legacy terminal transmitting the PPDU should set the L_LENGTH field as shown in Equation 2 below.

$$L\_LENGTH ( byte ) = ( ⌈ \frac{TXTIME - 20}{4} ⌉ ) \times 3 - 3 \qquad [ Equation 2 ]$$

Herein, TXTIME is the total transmission time constituting the corresponding PPDU, and is expressed by Equation 3 below. In this case, TX represents the transmission time of X.

$$TXTIME ( us ) = {T}_{L - STF} + {T}_{L - LTF} + {T}_{L - SIG} + {T}_{R L - SIG} + {T}_{U - SIG} + ( {T}_{EHT - SIG - A} ) + ( {T}_{EHT - SIG - B} ) + {T}_{EHT - STF} + {N}_{EHT - LTF} \cdot {T}_{EHT - LTF} + {T}_{DATA} \qquad [ Equation 3 ]$$

Referring to the above Equations, the length of the PPDU is calculated based on the ceiling value of L_LENGTH/3. Therefore, for any k value, three different values of L_LENGTH={3k+1, 3k+2, 3 (k+1)} indicate the same PPDU length.

Referring to (e) of FIG. 7, the U-SIG (Universal SIG) field persists in EHT/UHR PPDUs and subsequent generation wireless LAN PPDUs, serving to distinguish which generation PPDU it belongs to, including EHT/UHR. Additionally, the U-SIG field may facilitate spatial reuse for EHT/UHR and subsequent generation wireless LANs. The U-SIG may be a 64FFT-based OFDM 2 symbol, and may transmit a total of 52 bits of information. Of these, 43 bits, excluding the CRC/Tail 9 bits, are broadly divided into a version independent (VI) field and a version dependent (VD) field.

The VI bit may continue to maintain the current bit configuration in the future, so that even if a PPDU of a subsequent generation is defined, the current EHT/UHR terminals may obtain information about the PPDU through VI fields of the PPDU. To this end, a VI field includes PHY version, UL/DL, BSS color, TXOP, and reserved fields. The PHY version ID field is 3 bits and serves to sequentially distinguish EHT/UHR and subsequent generation wireless LAN standards by versions. The PHY version ID field of the EHT (11be) PPDU has a value of 000b, and the PHY version ID field of the UHR PPDU has a value other than 000b. The UL/DL field distinguishes whether the relevant PPDU is an uplink/downlink PPDU. The BSS color refers to a BSS-specific identifier defined in 11ax, and has a value of 6 bits or more. A TXOP refers to a transmit opportunity duration that has been transferred in a MAC header, and by being added to a PHY header, the length of the TXOP, in which the PPDU is included, may be inferred without the need to decode an MPDU, and has a value of 7 bits or more.

The VD field in EHT may indicate signaling information useful only for the 11be version PPDU, and may include a field that is commonly used in any PPDU format such as a PPDU format and BW, and a field that is differently defined for each PPDU format. The PPDU format is an identifier for distinguishing between EHT single user (SU), EHT multiple user (MU), EHT trigger-based (TB), EHT extended range (ER) PPDUs, and the like.

The BW field may signal 5 basic PPDU BW options of 20, 40, 80, 160 (80+80), and 320 (160+160) MHz (BW expressible in the form of 20×2n may be referred to as a basic BW), and various other PPDU bandwidths configured through preamble puncturing. In addition, after signaled as 320 MHz, the PPDU BWs may be signaled in the form in which some 80 MHz punctured. In addition, the punctured and modified channel formed may be signaled directly in a BW field, or may be signaled by using both the BW field and a field (for example, a field in the EHT-SIG field) that appears after the BW field. If the BW field is 3 bits, a total of 8 BW signaling options are possible, and thus in the puncturing mode, up to 3 BW signaling options may be signaled. If the BW field is 4 bits, a total of 16 BW signaling options are possible, and thus in the puncturing mode, up to 11 BW signaling options may be signaled.

The VD field of UHR is a field for indicating signaling information useful only for the UHR PPDU. However, the information indicated by each field included in the VD field of a UHR PPDU may be the same as information indicated by a field that plays the same role as the VD field of EHT (11be), or may be an extended form thereof. For example, a field indicating a puncturing pattern included in the VD field of the UHR PPDU may indicate more diverse types of patterns than a field indicating a puncturing pattern included in the VD field of the EHT PPDU. Alternatively, the field indicating the puncturing pattern included in the VD field of the UHR PPDU may be interpreted in combination with the BW field. This makes it possible to indicate more diverse types of puncturing patterns.

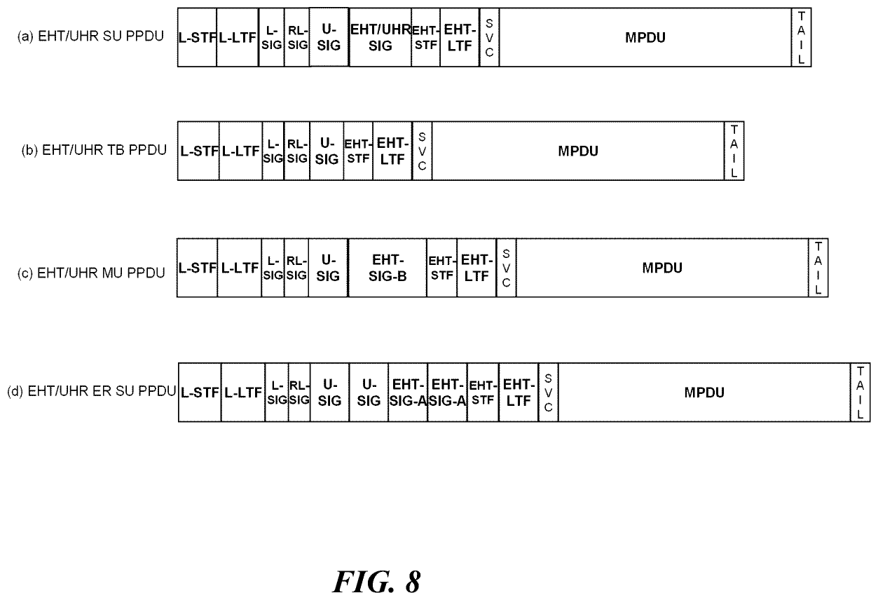

FIG. 8 illustrates an EHT/UHR PPDU format according to an embodiment of the present disclosure.

The EHT/UHR PPDU format may be indicated by the PPDU Format field of the U-SIG field of a PPDU. FIG. 8A illustrates an EHT/UHR SU PPDU according to an embodiment of the present disclosure. The EHT/UHR SU PPDU may be a PPDU used for single-user transmission between an AP and a single station, and may include an EHT-SIG-A field for additional signaling after U-SIG.
(b) of FIG. 8 illustrates an EHT/UHR trigger-based PPDU according to an embodiment of the present disclosure. The EHT/UHR trigger-based PPDU is an uplink PPDU used for transmission in response to a trigger frame, and may not have a separate EHT/UHR-SIG-A field after U-SIG.
(c) of FIG. 8 illustrates an EHT/UHR MU PPDU according to an embodiment of the present disclosure. The EHT/UHR MU PPDU is a PPDU used for transmission to one or more terminals. An EHT/UHR MU PPDU format may include HE-SIG-B after a U-SIG field.
(d) of FIG. 8 illustrates an EHT/UHR ER SU PPDU according to an embodiment of the present disclosure. The EHT/UHR ER SU PPDU is used for single-user transmission to a station in the extended range. An EHT/UHR ER SU PPDU format may have a U-SIG repeated in the time axis.

The EHT/UHR MU PPDU described with reference to FIG. 8C may be used by an AP to perform downlink transmission to a plurality of stations. In this case, the EHT/UHR MU PPDU may include scheduling information for multiple stations to simultaneously receive the PPDU. In this case, the EHT/UHR MU PPDU may transfer AID information of a receiver or transmitter of the PPDU through a user-specific field of the EHT/UHR-SIG-B. A station that has received an EHT/UHR MU PPDU may perform a spatial reuse operation, based on the AID information acquired from the PPDU's preamble. More specifically, the resource unit allocation (RA) field of the EHT/UHR-SIG-B may include information about a resource unit (RU) division form in a specific bandwidth (e.g., 20 MHz) in the frequency domain. In addition, information about a station designated for each divided resource unit may be transferred through a user-specific field of the EHT/UHR-SIG-B. The user-specific field may include one or more user fields corresponding to each divided resource unit.

An AID of a receiver or a transmitter may be inserted in a user field corresponding to a resource unit in which data transmission is performed, among the multiple divided resource units. A pre-designated null STA ID may be inserted into a user field corresponding to the remaining resource units in which data transmission is not performed.

Two or more PPDUs described with reference to FIG. 8 may be indicated by the same PPDU format. For example, the value of the U-SIG PPDU format subfield indicating an EHT/UHR SU PPDU and the value of the U-SIG PPDU format subfield indicating an EHT/UHR MU PPDU may equal.

Some of the fields included in the PPDU format described above, or some information of the fields, may be omitted. This may be referred to as a compression mode or a compressed mode.

### <Method for Channel Access of Wi-Fi Terminal>

Wi-Fi terminals (AP, non-AP STA, etc.) perform communication by using an unlicensed band, and thus, before performing frame transmission, identify whether a channel on which the terminals intend to use for transmission is being used by another device. Carrier sense multiple access (CSMA) is a channel access method in which a terminal intending to transmit a packet performs carrier sense to determine whether a channel is being used by another device, and performs transmission only when the channel is determined to be not being used by the other device (idle). A terminal using CSMA, when a medium (channel) is identified as being used at least another device (is determined to be busy), may perform an operation that avoids attempting transmission, and therefore, a transmission started first may be protected from other device.

However, when multiple terminals that have discovered that a medium has been occupied by another device attempt to transmit packets simultaneously when the medium occupation by the other device is confirmed to have ended (the medium becomes idle), thereby experiencing a transmission collision. That is, when a specific terminal attempts to transmit a packet and concurrently multiple other terminals also attempt to transmit packets, a terminal that should receive the packet transmitted by the specific terminal may fail to properly receive and decode the packet to be received, due to interference caused by the transmission performed by the multiple other terminals.

As described above, CSMA with collision avoidance (CSMA/CA) is a channel access mechanism that prevents multiple terminals, having detected the medium becoming idle, from attempting packet transmission simultaneously. Terminals that access a medium (channel) by using CSMA/CA attempt transmission after waiting for a random time, when the state of the medium observed by the terminals becomes idle. The random time may be aslottime (which may be 9 μs in general) multiplied by a random number (random backoff counter) generated by each terminal attempting transmission. That is, unlike in the case of using only CSMA, the terminals that access the medium by using CSMA/CA attempt transmission at different times because the terminals wait for different random times before attempting transmission. In this case, when a specific terminal having waited for the shortest random time after the medium becomes idle attempts the first transmission, other terminals may stop the channel access procedure after discovering that the medium has been occupied (become busy) by the specific terminal. In this case, the specific terminal may perform an operation of decrement the backoff counter maintained by the specific terminal by 1 at each aslottime while the medium remains idle, and may attempt transmission when the backoff counter reaches 0 or, alternatively, when the aslottime has passed after the backoff counter has reached 0. In this case, the specific terminal that has performed the transmission may generate a new random number (a new backoff counter) after the transmission is completed, and then may attempt transmission when the new random number again reaches 0 or after the new random number reaches 0.

The above-mentioned CSMA/CA and random backoff procedures are commonly applied to basic functions used when Wi-Fi terminals attempt channel access, i.e., a distributed coordination function (DCF) and an enhanced distributed channel access (EDCAF). The procedures are well-known and widely used unlicensed band channel access methods, and thus a more detailed description thereof will be omitted.

The DCF and the EDCAF used by a Wi-Fi terminal's MAC evaluate the channel status by considering not only the channel state (idle or busy) that has been directly identified by each terminal by performing a physical carrier sense (CS) but also the result of a virtual CS (virtual CS). More specifically, even if the result of physical (physical) CS performed for a channel is idle, the Wi-Fi terminal considers the channel state to be busy if a virtual CS result is busy. In this case, the virtual CS is a channel evaluation method for determining a channel to be busy when the network allocation vector (NAV) is not 0. The NAV may be a value maintained for future traffic that is predicted to occupy a medium. More specifically, when the Wi-Fi MAC has received an RTS/CTS frame, the MAC may configure an NAV (NAV count) based on duration information of the received frame, for example, the value of a duration field, and may maintain the NAV as a value other than 0 during the time in which the medium is expected to be occupied after RTS/CTS frame exchange. That is, a value maintained by the NAV is reduced as time passes. If a specific MAC has an NAV value of 0, it may be interpreted that the medium is no longer occupied by the future traffic that the specific MAC had discovered. If the NAV is 0, the MAC may determine the virtual CS result to be idle. In this case, the Wi-Fi MAC may configure the NAV, not only based on the RTS/CTS frame, but also based on a duration value acquired from another received MAC frame.

The channel evaluation method (determine the state of the medium) that considers both the physical CS and virtual CS results, briefly described above, is also one of well-known Wi-Fi MAC functions, and thus a detailed explanation thereof will be omitted.

### <EDCA and TXOP>

EDCA provides a mechanism to manage traffic by differentiating the traffic into four types of access categories (ACs) according to the characteristics of the traffic. In this case, the four types of ACs may be AC_VO (AC Voice), AC_VI (AC Video), AC_BE (AC Best effort), and AC_BK (AC Background), and the ACs may have different contention windows (CWs), transmit opportunity (TXOP), and AIFSN parameters. In short, EDCA is a mechanism for differentiating CWs, TXOP, and AIFSN parameters for four types of ACs and adjusting the transmission priority of traffic transmitted by using each AC. To this end, EDCA may map traffic (MSDU) that the MAC should service to one of the four ACs according to a traffic category (TC) or a traffic stream (TS). The traffic mapped to one of four ACs by EDCA is managed separately in four queues for respective ACs. In this case, the four queues may be logically separated queues, rather than physically separated queues.

AC_VO may be an AC to be used for traffic which, like such as voice traffic, is not large in the absolute amount of traffic but is vulnerable to transmission delay, and has relatively small CW and AIFSN parameter values in order to increase the probability of being preferentially served compared to the traffic of other ACs. The TXOP parameter of AC_VO is limited to a value relatively smaller than the TXOP parameters of other ACs, and thus, only a short transmission time is ensured compared to other ACs.

AC_VI is an AC that can be used for traffic, such as video, which is more tolerant to transmission delays than voice traffic but still requires low-latency transmission and in which a large volume of traffic is required to be processed. AC_VI has CW and AIFSN parameter values that are larger than those of AC_VO but smaller than those of other ACs, and instead, the TXOP is approximately twice as long as that of AC_VI.

AC_BE is an AC that may be used for traffic tolerant to transmission delay, and most general traffic excluding voice data and streaming video data, may be classified as AC_BE. AC_BE uses CW and AIFSN parameters having values larger than those of AC_VO and AC_VI. In addition, AC_BE does not have a separate TXOP. Therefore, traffic corresponding to AC_BE cannot be used in a TXOP transmission sequence in which a PPDU is transmitted, an ACK is received in response thereto, and then a PPDU is transmitted again after SIFS.

AC_BK is an AC that may be used for traffic which is tolerant to transmission delay, like AC_BE, but has a lower priority than BE traffic. AC_BK uses the same CW parameter value as AC_BE, and uses a larger AIFSN parameter value than AC_BE. In addition, traffic corresponding to AC_BK, like AC_BE, does not have a separate TXOP and thus may not be used in a TXOP transmission sequence.

The four types of EDCA ACs are mapped to the user-priority (UP) of 802.1D, and the EDCA AC is determined according to the UP value of traffic received through a wire or the TID of an MSDU indicated from the upper layer. In this case, when the TID of the MSDU indicates a value of 0 to 7, the value indicated by the TID may be mapped one-to-one to the UP.

Furthermore, the four types of EDCA ACs have respective default CW (CWmin, CWmax), AIFSN, and TXOP parameters defined in the standard, and the parameter values of each AC may be changed by the AP, allowing different values to be used for each BSS.

By using the EDCA mechanism, Wi-Fi traffic may be stored in one of the four queues corresponding to the four ACs, and may be transmitted to a destination device only when the AC including the traffic wins the channel access competition against other ACs. In this case, each AC performs competition by using the access parameters (CW[AC], AIFSN[AC]) allocated to the AC in the channel access competition between the ACs, and the channel access competition operation performed by each AC is the same as that of DCF. In this case, if a specific AC has no traffic to be transmitted to the queue, the specific AC may not participate in the competition.

However, as described above, the CW and AIFSN parameter values used by the ACs are different, and thus the AC_VO having the smallest CW and AIFSN parameters has a high probability of winning in channel access competition with other ACs, and therefore, the traffic of AC_VO is likely to be preferentially served over the traffic of other ACs.

Furthermore, the EDCA mechanism defines internal competition rules, such as allowing a high-priority AC to win when an (internal) collision occurs between the ACs and increasing the CW of other ACs that caused the collision, and rules for constructing a PPDU including traffic of other ACs other than the AC which has won the competition (the primary AC). However, since the rules are not closely related to the proposal of the present disclosure, a detailed description thereof will be omitted.

EDCA provides, in addition to the function of operating a differentiated AC according to the type of traffic (frame, packet, etc.) for QoS enhancement as described above, an EDCA transmission opportunity (EDCA TXOP) function. An EDCA TXOP refers to a time during which, when an EDCA function (EDCAF) of a specific AC has acquired a channel access opportunity, i.e., has become a TXOP holder, a medium can be controlled without being disturbed by other devices during the TXOP duration. In this case, the EDCA TXOP may be limited by a TXOP limit advertised by an AP. The TXOP holder should ensure that the TXOP holder's transmission and transmission of a response frame in response to the TXOP holder's transmission are completed within the TXOP limit.

The TXOP holder may transmit multiple frames (multiple PPDU) during the EDCA TXOP duration. When the transmission of each frame is performed within the obtained TXOP duration, the TXOP holder may continuously transmit multiple frames without performing a separate channel access procedure, for example, a backoff procedure, between transmissions of the frames. In this case, when the multiple frames are MPDUs or aggregated MAC protocol data units (A-MPDUs) that do not request immediate ACK, the transmission of the multiple frames may be performed at a short interframe space (SIFS) or reduced interframe space (RIFS) interval. In this case, when there is an MPDU or A-MPDU requesting an immediate ACK among the multiple frames, the TXOP holder may transmit the frame requesting the immediate ACK, receive the ACK, and then transmit the next frame after SIFS.

In this case, when traffic (packet, frame, etc.) of another AC other than the specific AC which is the TXOP holder satisfies a specific condition, the traffic may be also transmitted within the TXOP acquired by the TXOP holder (the specific AC). The transmission of the traffic of the AC other than the TXOP holder within the TXOP may be an operation by TXOP sharing between the ACs, and details regarding the specific condition are unrelated to the present disclosure, and thus will be omitted.

As described above, a TXOP holder may perform continuous frame transmission without performing a separate channel access procedure within the TXOP. This may be an operation that may be achieved when other terminals understand and protect the TXOP duration acquired by the TXOP holder. That is, to acquire a medium control right regarding the EDCA TXOP duration, the TXOP holder may need a procedure to notify other terminals of the acquired TXOP duration so that the other terminals can discover the TXOP duration.

To this end, a terminal (AC) that has become a TXOP holder, or that has completed a channel access procedure and has started transmission, may attempt to transmit an RTS frame to allow another terminal to discover the TXOP duration. In this case, the RTS frame refers to a frame in which the Type subfield (fourth bit B3 and third bit B2) of the Frame Control field of an MAC frame header is set to 01b (Type=control frame), and the Subtype subfield (eighth bit B7, seventh bit B6, sixth bit B5, and fifth bit B4) of the Frame Control field is set to 1011b. The other terminal that has received the RTS frame from the TXOP holder may configure a NAV, based on information regarding a duration included in the RTS frame, for example, a value of a duration field. The configured NAV may be maintained at a value other than 0 during a time corresponding to the TXOP of the TXOP holder. However, a terminal indicated as a destination device of the RTS frame must respond to a CTS frame, instead of configuring the NAV, based on the information of the RTS frame. In this case, the destination device of the RTS frame transmitted to start the TXOP is a TXOP responder, and must transmit a CTS frame (after the RTS frame is received and after SIFS) in response to the RTS. In this case, the duration field of the responding CTS frame is set to a value calculated by: a value indicated by the duration field of the received RTS frame-CTS frame transmission time-SIFS. Terminals having received the CTS frame may configure a NAV, based on information (e.g., the value of the duration field) related to the duration included in the CTS frame.

Therefore, the NAV of a terminal that has received an RTS frame from the TXOP holder and the NAV of a terminal that has received a CTS frame from the TXOP responder are configured to be 0 after the TXOP obtained by the TXOP holder ends. Through this, the Wi-Fi MAC mechanism may protect the TXOP holder and the TXOP responder so that the TXOP holder and the TXOP responder can exchange multiple frames without being disturbed during the TXOP.

However, in a case where the TXOP holder transmits the RTS frame as a non-HT duplicate PPDU over the primary 80 MHz bandwidth, but the CTS frame (non-HT duplicate PPDU) responded by the TXOP responder is responded only in the primary 40 MHz bandwidth, the TXOP holder may use only a bandwidth of the primary 40 MHz or less than the primary 40 MHz, for example, the primary 20 MHz, for frame exchange during the acquired TXOP. The CH_BANDWIDTH (a type of TXVECTOR parameter) of the PPDU transmitted by the TXOP holder should be configured to be a value equal to or smaller than the CH_BANDWIDTH_IN-NON_HT (a type of RXVECTOR parameter) of the received CTS frame. In this case, the RTS frame may be an RTS frame that allows a CTS frame to be responded in a BW smaller than a BW in which the RTS frame is transmitted. The RTS frame may be an RTS frame transmitted with DYN_BANDWIDTH_IN_NON_HT (a type of parameter) TXVECTOR dynamically configured. If DYN_BANDWIDTH_IN_NON_HT is statically configured and an RTS frame is transmitted from the TXOP holder, the TXOP responder may be required to respond with a CTS frame by using the same BW as a BW in which the RTS frame has been received.

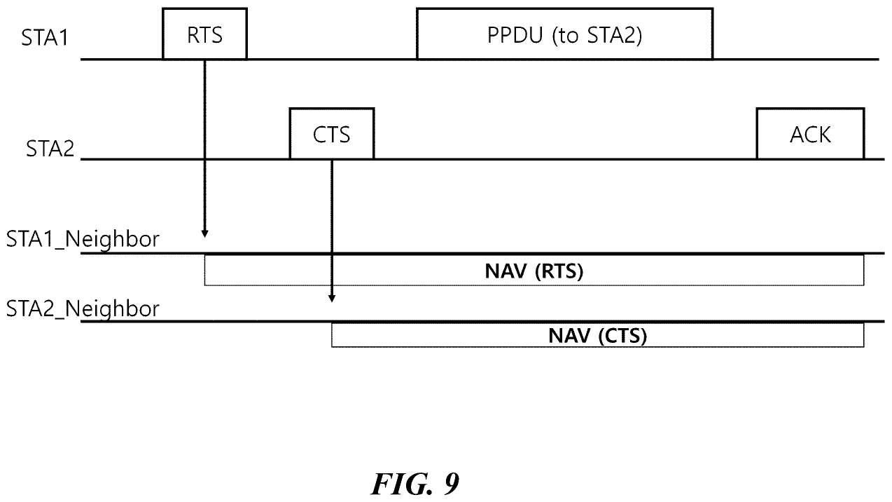

FIG. 9 illustrates a transmission/TXOP protection method using an RTS frame and a CTS frame according to an embodiment of the present disclosure.

Before transmitting a PPDU, a first station (STA1) transmits an RTS frame to a second station (STA2) which is a destination device of the PPDU, and the second station (STA2) may respond with a CTS frame after discovering that the received RTS frame is an RTS frame indicating the second station as a destination device and after SIFS.

STA1_Neighbor, which is a neighboring station (Neighbor STA) of the first station (STA1), receives the RTS frame transmitted by the first station (STA1), and then configures an NAV, based on a value indicated by the duration field of the RTS frame. STA2_Neighbor, which is a neighboring station of the second station (STA2), receives the CTS frame transmitted by the second station (STA2), and then configures an NAV, based on information indicated by the duration field of the CTS frame. STA1_Neighbor and STA2_Neighbor, after receiving the RTS/CTS frame, determine that a virtual CS is not busy while the configured NAV (counter) is maintained at a value other than 0, and perform an operation such as not reducing a backoff counter. As a result, a neighbor terminal having received the RTS/CTS frame does not attempt transmission during a duration in which the NAV is maintained at a value other than 0. Therefore, the first station (STA1) and the second station (STA2) may not be disturbed by neighboring terminals during the exchange of a PPDU and an Ack frame.

Even if the first station (STA1) and STA2_Neighbor are in a hidden relationship in which signals from each other's transmissions are not detected, STA2_Neighbor can perform an operation considering that a channel (WM, wireless medium) is in use while the first station (STA1) transmits a PPDU.

### <TXOP Protection Using MU-RTS Trigger Frame>

11ax (6th generation Wi-Fi, Wi-Fi6, HEW, High Efficiency WLAN) defines an MU-RTS trigger/CTS frame exchange procedure and adds a function allowing an AP to start a TXOP and protect a TXOP frame exchange procedure by using an MU-RTS trigger frame (hereinafter, MU-RTS or MU-RTS frame). The MU-RTS frame is a type of trigger frame, and a station that receives an MU-RTS frame and has AID12 (LSB 12 bits of the association ID) indicated by the user field included in the MU-RTS frame responds with a CTS frame at the same time. When the AP uses an MU-RTS frame to protect a TXOP, multiple stations respond with CTS frames, and thus the TXOP may be protected from neighboring devices of the multiple stations, which are the destination devices of a downlink multi user PPDU ((DL MU) PPDU). In addition, the MU-RTS frame may be used to protect a UL MU PPDU. More specifically, before requesting a trigger based (TB) PPDU from multiple stations through a trigger frame, the AP may transmit an MU-RTS frame to cause the multiple stations, which will respond with the TB PPDU, to respond with a CTS frame. In this case, the CTS frames responded by the multiple stations may induce the neighboring station of each station to configure a NAV so as to protect a TB PPDU and an Ack frame (Ack, Block Ack, etc.) to be transmitted after the TB PPDU, and thus legacy stations (STAs) which cannot discover (interpret, decode) the trigger frame and the TB PPDU may not perform channel access during a packet exchange sequence period (or TXOP) initiated via the trigger frame.

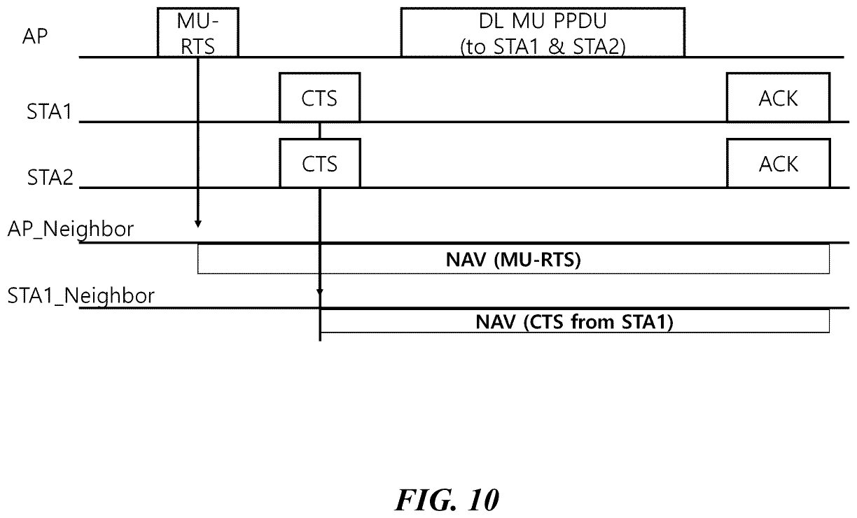

FIG. 10 illustrates a transmission/TXOP protection method using an MU-RTS frame and a CTS frame according to an embodiment of the present disclosure.

In the embodiment of FIG. 10, before transmission of a MU PPDU, an AP transmits an MU-RTS frame to a first station (STA1) and a second station (STA2) which are the destination devices of the MU PPDU, and the first station (STA1) and the second station (STA2) receive the MU-RTS frame, and each of the stations responds to the MU-RTS frame by using a CTS frame after SIFS.

A neighboring station STA1_Neighbor of the first station (STA1) receives a CTS frame transmitted by the first station (STA1), and then configures an NAV, based on information indicated by the duration field of the CTS frame. A neighboring station STA2_Neighbor of the second station STA2 receives a CTS frame transmitted by the second station STA2, and then configures a NAV, based on information indicated by the duration field of the CTS frame. While Virtual CS (virtual carrier sense) is determined to be busy while the NAVs (counter) configured after reception of the CTS frames are maintained at a value other than 0, STA1_Neighbor and STA2_Neighbor determines virtual carrier sense (virtual CS) and perform an operation such as not reducing a backoff counter. Therefore, each of the neighboring terminals that have received the CTS frames does not attempt transmission during the duration in which the NAV is maintained at a value other than 0. Through this, the AP may transmit an MU PPDU, and the first station (STA1) and the second station (STA2) may not be disturbed by the neighboring terminals while transmitting Ack frames.

The trigger frame described above is a frame type defined in 11ax, in which type (the fourth bit B3 and the third bit B2) and subtype (the eighth bit B7, the seventh bit B6, the sixth bit B5, and the fifth bit B4) subfields of a Frame Control field are configured to be 01b and 0010b, respectively. The trigger frame is a control type frame in which the type subfield of the Frame Control field is 01b, and a subtype value, 0010, indicates a trigger frame type. 11ax defines a trigger frame such that an AP may request response frames from multiple stations at one time, and an MU-RTS frame is used by the AP to request a CTS frame from multiple stations (non-AP STAs). Trigger types other than the MU-RTS frame include a basic trigger frame which requests a UL MU PPDU, a beamforming report poll (BRP) trigger frame which requests a beamforming report, an MU-BAR trigger frame which requests BlockAck, a buffer status report poll (BSRP) trigger frame which requests a buffer status report), a GCR MU-BAR trigger frame, a bandwidth query report poll (BQRP) trigger frame, and a NDP feedback report poll trigger frame. The trigger types other than the MU-RTS frame are not related to the subject matter of the present disclosure, and thus a detailed description thereof will be omitted.

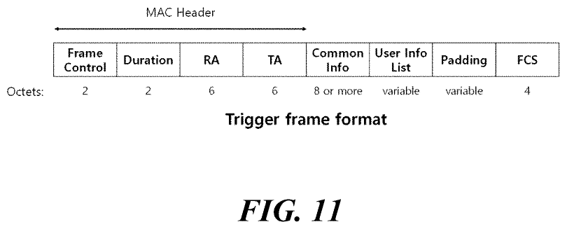

FIG. 11 illustrates a format of a trigger frame according to an embodiment of the disclosure.

The trigger frame includes a MAC header including a Frame Control field, a Common Info field, a User Info List field, a Padding field, and an FCS field.

The Frame Control field includes a Type and a Subtype subfield, and in the trigger frame, the values of the two subfields are configured as 01b and 0010b, respectively.

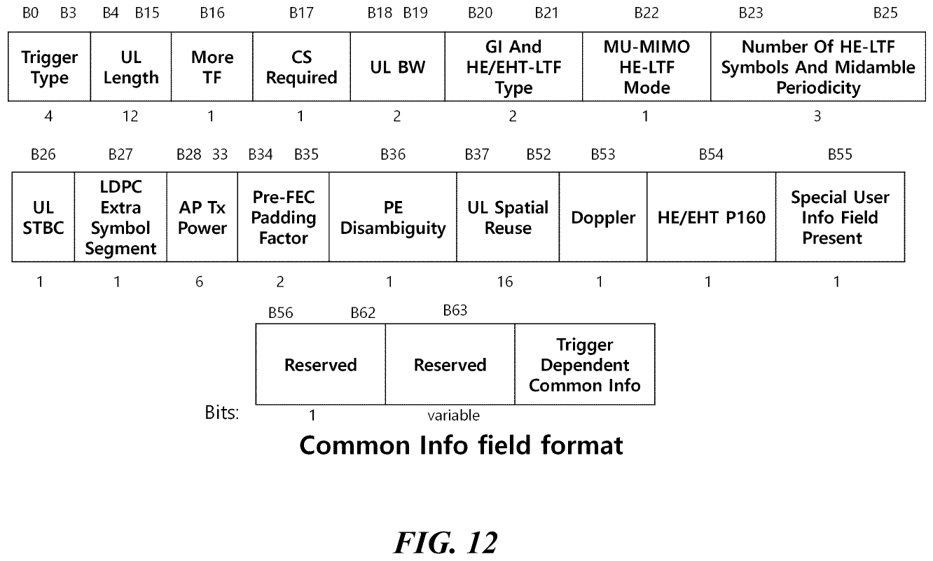

The Common Info field includes a Trigger Type subfield for indicating the type of the trigger frame and a UL Length subfield for indicating the length of the UL transmission to be responded to, and detailed information is described in detail through an embodiment of FIG. 12.

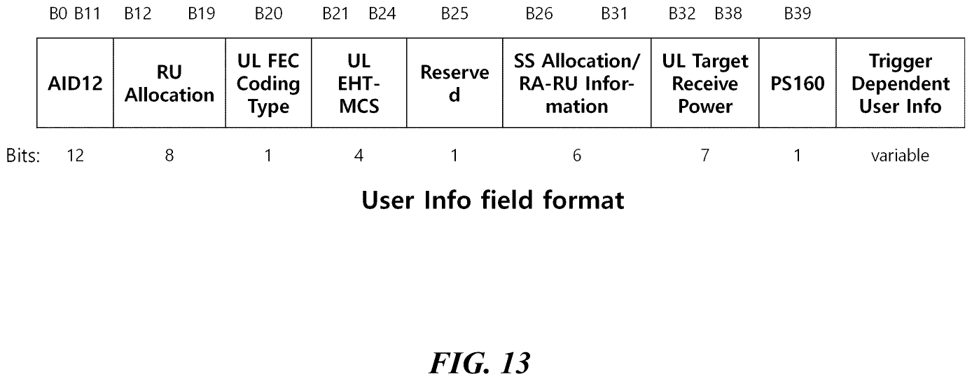

The User Info List field may include a User Info field that includes information indicating a destination device of the trigger frame. In this case, in addition to information indicating the destination device, the User Info field also includes information on parameters used by the destination device when transmitting a response frame after receiving the trigger frame, such as UL DCM or UL MCS, depending on the type of the trigger frame. The details of the User Info field are described in detail with reference to FIG. 13.

The padding field is a field configured to secure time for a station that receives the trigger frame to prepare for transmission of a response frame, such as a UL TB PPDU or a CTS frame. The AP transmitting the trigger frame may adjust the length of the Padding field in consideration of the performance of the destination devices. In addition, in 11be (Wi-Fi 7, EHT), the end time of the PPDU including the trigger frame may be added/adjusted to align the same with another PPDU, but a detailed description thereof is omitted.

The Frame Check Sequence (FCS) field includes a 32-bit cyclic redundancy code (CRC), and is a value calculated by including the MAC header and Frame Body fields. The function and configuration method of the FCS field in the trigger frame are the same as the function and configuration method of the FCS field in a conventional MAC frame. A separate description thereof is omitted.

FIG. 12 illustrates a format of a Common Info field of a trigger frame according to an embodiment of the disclosure.

Trigger Type subfield indicates a type (variant) of the trigger frame. When the value of the Trigger Type subfield is 0, the Trigger Type subfield indicates a basic trigger frame. When the value of the Trigger Type subfield is 1, the Trigger Type subfield indicates a beamforming report poll (BFRP) trigger frame. When the value of the Trigger Type subfield is 2, the Trigger Type subfield indicates an MU-BAR frame. When the value of the Trigger Type subfield is 3, the Trigger Type subfield indicates an MU-RTS frame. When the value of the Trigger Type subfield is 4, the Trigger Type subfield indicates a BSRP frame. When the value of the Trigger Type subfield is 5, the Trigger Type subfield indicates a GCR MU-BAR frame. When the value of the Trigger Type subfield is 6, the Trigger Type subfield indicates a bandwidth query report poll (BQRP) frame. When the value of the Trigger Type subfield is 7, the Trigger Type subfield indicates an NDP feedback report poll (NFRP) frame.

UL Length subfield indicates a value to be configured in the L-SIG LENGTH field of the TB PPDU responded to through the trigger frame.

More TF subfield indicates whether there are more trigger frames to be transmitted after the trigger frame including the More TF subfield.

CS Required subfield indicates whether the destination device of the trigger frame needs to perform CS (physical and virtual CS, ED and NAV) when transmitting a response frame. When the value of the CS Required subfield is 1, the station that receives the trigger frame including the CS Required subfield must perform CS before transmitting a response frame to the trigger frame.

UL BW subfield indicates a value of the BW field that the STA responding with the TB PPDU after receiving the trigger frame needs to configure in the preamble, for example, HE-SIG-A or U-SIG.

GI And HE/EHT-LTF Type subfield indicates a guard interval (GI) and an HE/EHT-LTF value of a TB PPDU to be responded to.

MU-MIMO HE (EHT)-LTF Mode subfield indicates information related to the HE (EHT)-LTF mode to be applied to the TB PPDU to be responded to.

When the value of the Doppler subfield is 0, the Number Of HE (EHT/UHR)-LTF Symbols And Midamble Periodicity subfield indicates the number of HE (EHT)-LTF symbols that should be applied to the TB PPDU. When the value of the Doppler subfield is 1, the Number Of HE (EHT/UHR)-LTF Symbols And Midamble Periodicity subfield indicates information related to the number of HE (EHT)-LTF symbols and the periodicity of the midamble.

UL STBC subfield indicates whether STBC encoding should be applied to the TB PPDU that is a response to the trigger frame including the UL STBC subfield. When STBC encoding needs to be applied, the value of the UL STBC subfield is configured to 1. The value of the UL STBC subfield in the trigger frame that triggers the EHT/UHR TB PPDU is reserved.

LDPC Extra Symbol Segment subfield indicates whether an LDPC extra symbol segment should appear in a TB PPDU that is a response to the trigger frame including the LDPC Extra Symbol Segment subfield. When the value of the LDPC Extra Symbol Segment subfield is 1, the TB PPDU that is a response to the trigger frame including the LDPC Extra Symbol Segment subfield includes an LDPC extra symbol segment.

AP Tx Power subfield indicates a value related to the transmission power used by the AP that transmitted the trigger frame when transmitting the trigger frame. The station that receives the trigger frame may adjust the transmission power of the response frame for the trigger frame, based on the value indicated by the AP Tx Power subfield.

Pre-FEC Padding Factor and the PE Disambiguity subfields indicate whether the Pre-FEC Padding Factor is 1, 2, 3, or 4, and information for clarifying the length of the packet extension (PE).

UL Spatial Reuse subfield includes four Spatial Reuse subfields and indicates a value to be configured in the Spatial Reuse field of the TB PPDU that is a response to the trigger frame including the UL Spatial Reuse subfield.

Doppler subfield indicates whether a midamble is included in the TB PPDU that is a response to the trigger frame including the Doppler subfield. The trigger frame that triggers an EHT/UHR TB PPDU may have the Doppler subfield configured to “reserved”. In this case, configuring the subfield to “reserved” may indicate that the station operates without considering the presence and value of the Doppler subfield after receiving the trigger frame.

Special User Info Field Present subfield indicates whether a User Info field in which an AID12 subfield is indicated by 2007 or a predesignated value is indicated among the User Info fields.

Trigger Dependent Common Info subfield is a field that is included in the trigger frame only when the type of the trigger frame indicated by the Trigger Type field is a basic trigger frame or an NFRP trigger frame.

FIG. 13 illustrates a format of a User Info field of a trigger frame according to an embodiment of the disclosure.

AID12 subfield indicates information related to which station the User Info field including the AID12 subfield is for. A station having the same AID as the AID indicated by the AID12 subfield may determine that the trigger frame including the AID12 subfield includes the station as a destination device. In this case, the AID12 subfield may be configured to 1 to 2006 (1 to 2007 when the trigger frame is the HE Trigger) when indicating one combined station.

In this case, when the value of the AID12 subfield is 0, the AID12 subfield may indicate that one or more random access RUs (RA-RUs) are allocated to a station associated with the AP that transmits the trigger frame. When the trigger frame received by the station associated with the AP that transmits the trigger frame does not have the User Info field including the AID12 subfield indicating the station's AID, and has a User Info field with an AID12 subfield value of 0, the station may attempt TB PPDU transmission using the RA-RU.

In addition, when the value of the AID12 subfield is 2045, the AID12 subfield may indicate that one or more random access RUs (RA-RUs) are allocated to a station that is not associated with the AP that transmits the trigger frame. The station not associated with an AP may attempt to transmit a TB PPDU using an RA-RU when the trigger frame received by the station includes a User Info field with a value of 2045 in the AID12 subfield.

In addition, when the value of the AID12 subfield is 4095, the station receiving the trigger frame may determine that the padding field starts from the AID12 subfield. In this case, the station may not attempt to parse the remaining parts of the MAC frame after the AID12 subfield with the value of 4095.

In addition, when the value of the AID12 subfield is 2046, the AID12 subfield may indicate that the User Info field including the AID12 subfield indicates information on an unallocated RU to which no station is allocated.

The RU Allocation subfield of the trigger frame, except for the MU-RTS trigger frame, indicates the size and location information of the resource unit (RU)/multiple resource unit (MRU) allocated to the destination device of the User Info field including the RU Allocation subfield. The station may determine the information of the RU/MRU allocated to the station by interpreting the RU Allocation subfield and the PS160 subfield included in the User Info field together. The station may determine the information of the RU/MRU allocated to the station by interpreting the RU Allocation subfield and the PS160 subfield included in the User Info field and the PS320 subfield together. In this case, the PS320 subfield indicates whether the allocated RU is included in the primary 320 MHz band or in the secondary 320 MHz band among the 640 MHz bands. The PS160 subfield indicates whether an RU allocated in the 160 MHz band at a higher position on the frequency axis is included in the 320 MHz band (primary 320 MHz or secondary 320 MHz) indicated by the PS320 subfield or whether an RU allocated in the 160 MHz band at a lower position on the frequency axis is included. However, when the 320 MHz band indicated by the PS320 subfield is a primary 320 MHz, the information indicated by the PS160 subfield may indicate whether it is a primary 160 MHz or a secondary 160 MHz, rather than information on high/low on the frequency axis. Specifically, the 320 MHz band indicated by the PS320 subfield may be the primary 320 MHz. In this case, when the value of the PS160 subfield is 0, the PS160 subfield may indicate that the allocated RU is included in the primary 160 MHz band. When the value of the PS160 subfield is 1, the PS160 subfield may indicate that the allocated RU is included in the secondary 160 MHz band. In this case, the value of the PS160 subfield is an example. When the value of the PS160 subfield is 1, the PS160 subfield may indicate that the allocated RU is included in the primary 160 MHz band. When the value of the PS160 subfield is 0, the PS160 subfield may indicate that the allocated RU is included in the secondary 160 MHz band.

Within each 160 (and 320) MHz band indicated in this method, the method of indicating the location of the allocated RU may be the same as or similar to the method of indicating the RU Allocation subfield of the trigger frame defined in EHT.

The RU Allocation subfield of MU-RTS indicates a channel on which the destination device in the User Info field responds to the CTS frame. Specifically, the RU Allocation subfield of the MU-RTS frame indicates whether the destination device transmits the CTS frame only in the primary 20 MHz channel, or in the primary 40 MHz channel, primary 80 MHz channel, primary 160 MHz channel, 80+80 MHz channel, primary 320 MHz channel, or primary 640 MHz channel when transmitting the CTS frame. In this case, the MRU may represent a RU to which two or more RUs are combined, and 52+26, 106+26, 484+242, 996+484, 996+484+242, 2×996+484, 3×996, 3×996+484, 4×996, and 4×996+4×996-tone size MRUs may be used in the UHR.

UL FEC Coding Type subfield indicates the code type of the TB PPDU to be responded to. When the value of the UL FEC Coding Type subfield is 0 and the value of binary convolution coding (BCC) is 1, the UL FEC Coding Type subfield indicates low density parity check (LDPC).

UL EHT/UHR-MCS subfield indicates an EHT/UHR-MCS applied to transmission of the TB PPDU that is a response to the trigger frame.

SS Allocation/RA-RU Information subfield may be used as an SS Allocation subfield when the AID12 subfield is not allocated to the RA-RU. 6 bits of the SS Allocation subfield may include a 4-bit Starting Spatial Stream subfield and a 2-bit Number Of Spatial Streams subfield. When the value of the AID12 subfield is 0, 2044, or 2045, the User Info field including the AID12 subfield indicates information on the RA-RU.

UL Target Receive Power subfield indicates an estimated signal strength (power) value at which the TB PPDU that is a response to the trigger frame is received at the antenna of the AP. When the station transmits a TB PPDU, the station may adjust the transmission power of the TB PPDU depending on the value of the UL Target Receive Power subfield. Through this, the AP may receive the TB PPDU with the power predicted by the AP.

PS160 subfield, together with the RU Allocation subfield, indicates information on the position and size of the RU/MRU allocated by the User Info field including the PS160 subfield.

Trigger Dependent User Info (sub) field does not appear in the MU-RTS frame, so a detailed description thereof is omitted.

### <BSS Coverage Enhancement>

Ultra-High Reliability (UHR) aims to enhance the reliability of wireless LANs. The reliability enhancement may be achieved by providing lower transmission delay, stable jitter management, and more stable connectivity than EHT, which is 7th-generation Wi-Fi. In the provision of a more stable connectivity, the problem of disconnection caused by a limited coverage of a basic service set (BSS) and the problem of disconnection caused by a station moving out of the BSS coverage are becoming prominent.

The coverage of the BSS is physically and electrically determined based on the characteristics of the frequency band in which the BSS operates (e.g., signal attenuation), the transmission power of the UEs, and the reception sensitivity of the reception devices, and may be difficult to improve. In the case of mobile communication, the location of each base station is determined in consideration of the coverage of each base station, and the connectivity is ensured by connecting to a base station in an appropriate location depending on the location of each node. Connectivity of mobile communications is ensured by placing a base station so that all service areas are within the coverage of at least one base station. The wireless LAN environment built using Wi-Fi is not managed by a service provider like mobile communication. Therefore, it is difficult to expect a planned AP deployment considering the service area. A general user who constructs a wireless LAN environment in his or her home by using a single AP does not experience any problems in places close to the location of the AP, but in places where the AP signal is weak or in places in the home where the AP signal cannot reach, the user encounters problems of very slow communication speed and disconnection. As a solution to this, a method of constructing a mesh system (a system using a mesh access point) may be considered. However, a mesh AP needs to be additionally installed, and it is difficult for a general user to construct the mesh system due to the difficulty of determining the installation location of the mesh AP and configuring the connection.

Accordingly, in UHR, a method of installing a separate mesh AP is not considered, but a technology of expanding the coverage of an AP by performing relay by a non-AP station is being considered.

### <Coverage Expansion Through Relay>

In the disclosure, “relay” refers to multi-hop communication using an intermediate device and represents a communication method in which an MPDU transmitted by a transmission device is supported by a relay station (Relay STA) in the process of reaching the destination device. After the relay station receives the MPDU transmitted by the AP, the relay station performs the operation of transmitting the received MPDU to a destination station (Destination STA) that is the destination device of the MPDU, and performs the operation of transmitting the MPDU received from the destination station to the AP. This allows frame exchange between two devices that do not directly reach each other's transmissions.

The signal transmitted to the AP is difficult to be directly received by the destination station. Therefore, the operation of the relay station may be performed in advance according to the relay operation environment configuration between at least two of the AP, the destination station, and the relay station.

In the disclosure, a relay PPDU is not intended to refer to a specific PPDU format, but refers to a PPDU for transmitting an MPDU received from a transmission device to a destination station. Specifically, the relay PPDU is a PPDU used by the relay station for transmission to the destination station. The relay PPDU may be a UL PPDU or a TB PPDU. In this case, the UL PPDU may be an MU PPDU or an SU PPDU.

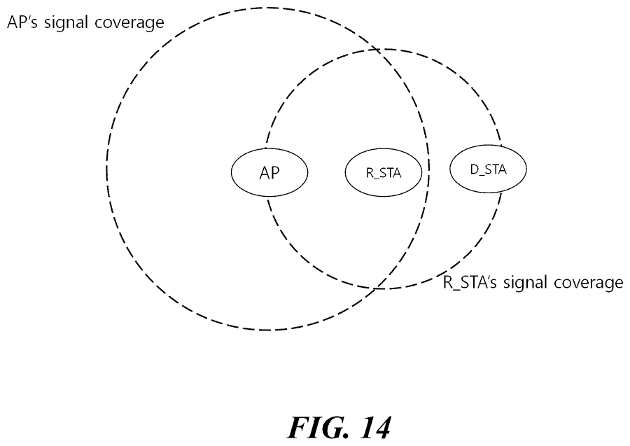

FIG. 14 illustrates a network including a relay station according to an embodiment of the disclosure.

In an embodiment of FIG. 14, a destination station (D_STA) is located outside the signal coverage of an AP. The AP transmits an MPDU to the destination station (D_STA) through a relay station (R_STA). In addition, the destination station (D_STA) transmits an MPDU to the AP through the relay station (R_STA).

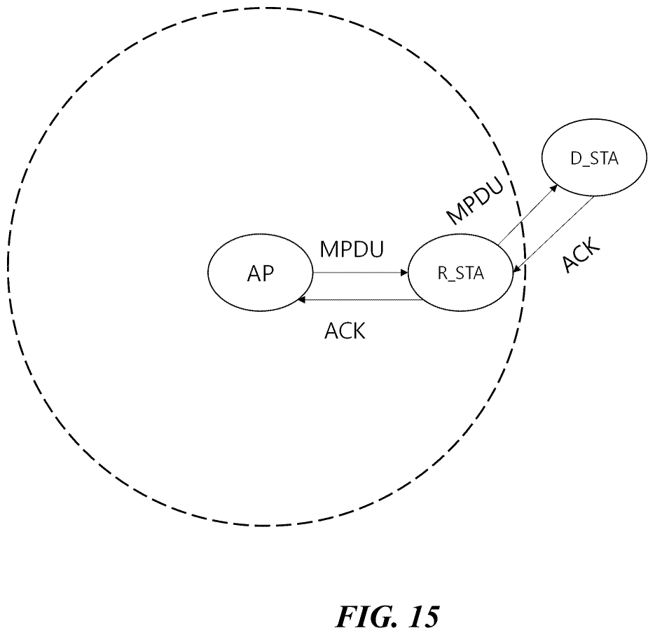

FIG. 15 illustrates an MPDU and ACK exchange procedure using a relay station according to an embodiment of the disclosure.

The AP transmits an MPDU to be transmitted to the destination station (D_STA) to the relay station (R_STA). The relay station (R_STA) determines that the MPDU received from the AP is an MPDU that needs to be transmitted to the destination station (D_STA). In this case, the relay station (R_STA) transmits the received MPDU to the destination station (D_STA). The destination station (D_STA) receiving the MPDU from the relay station (R_STA) transmits an Ack frame indicating that the MPDU has been successfully received to the relay station (R_STA). The relay station (R_STA) transmits the Ack frame received from the destination station (D_STA) to the AP.

### <Relay Discovery>

When the signal of the AP does not reach the destination station or is detected to be weaker than a predetermined level, the destination station may determine whether to perform a relay operation through the relay station. The destination station may identify whether there is a non-AP station that may operate as a relay station in the BSS to which the destination station belongs. Specifically, the non-AP station that wants to exchange frames with the AP through relay communication may find a non-AP station to operate as a relay station. Such an operation is referred to as relay discovery.

The destination station may determine whether the received PPDU has been transmitted by the non-AP station that is capable of operating as a relay station. When the PPDU received by the destination station is an Intra-BSS PPDU and the station that transmitted the PPDU is the non-AP station that is capable of operating as a relay station, the destination station may request the non-AP station to operate as a relay station. The non-AP station may signal that the non-AP station is capable of operating as a relay station in a signaling field of a physical layer of the PPDU or a MAC header. Specifically, the non-AP station may indicate that the non-AP station is capable of operating as a relay station by configuring a value of a predesignated field in the signaling field of the physical layer of the PPDU to a predesignated value. When the value of a predesignated field in the signaling field of the physical layer of the PPDU received by the destination station is a predesignated value, the destination station may determine that the station that transmitted the PPDU is capable of operating as a relay station. The predesignated field of the signaling field of the physical layer may be included in the U-SIG field. In addition, the predesignated field may be referred to as a relay support bit. In this case, when the value of the relay support bit is a first predesignated value, the relay support bit may indicate that the non-AP station transmitting the PPDU is capable of operating as a relay station. In addition, when the value of the relay support bit is a second predesignated value, the relay support bit may indicate that the non-AP station transmitting the PPDU is not capable of operating as a relay station. In addition, the non-AP station that does not support operating as a relay station, as well as the non-AP station that does not want to operate as a relay station, may configure the value of the relay support bit to the second predesignated value. The first predesignated value may be 1, and the second predesignated value may be 0. In addition, the DL PPDU may not include the relay support bit or may be reserved. In this case, the relay support bit may be included only in the UL PPDU. In addition, the relay support bit may be included in the Disregard field or the Validate field of the U-SIG field.

In addition, the non-AP station may indicate that the non-AP station is capable of operating as a relay station by configuring the value of the predesignated field in the MAC header of the MPDU to a predesignated value. When the value of a predesignated field in the MAC header of the MPDU received by the destination station is a predesignated value, the destination station may determine that the station that transmitted the MPDU is capable of operating as a relay station. In addition, the predesignated field may be referred to as a relay support bit. In this case, when the value of the relay support bit is a first predesignated value, the relay support bit may indicate that the non-AP station transmitting the MPDU is capable of operating as a relay station. In addition, when the value of the relay support bit is a second predesignated value, the relay support bit may indicate that the non-AP station transmitting the MPDU is not capable of operating as a relay station. In addition, the non-AP station that does not support operating as a relay station, as well as the non-AP station that does not want to operate as a relay station, may configure the value of the relay support bit to the second predesignated value. The first predesignated value may be 1, and the second predesignated value may be 0.

In addition, when the AP allows the non-AP station associated with the AP to signal whether the relay operation is supported, the non-AP station may signal whether the non-AP station is capable of operating as a relay station. In this case, when the AP does not allow the non-AP station associated with the AP to signal whether the relay operation is supported, the non-AP station may not be allowed to signal whether the non-AP station is capable of operating as a relay station. In addition, the AP may indicate whether to allow the non-AP station associated with the AP to signal whether the relay operation is supported by using a management frame. In this case, the management frame may include at least one of a beacon frame, a probe frame, and an operating mode notification frame.

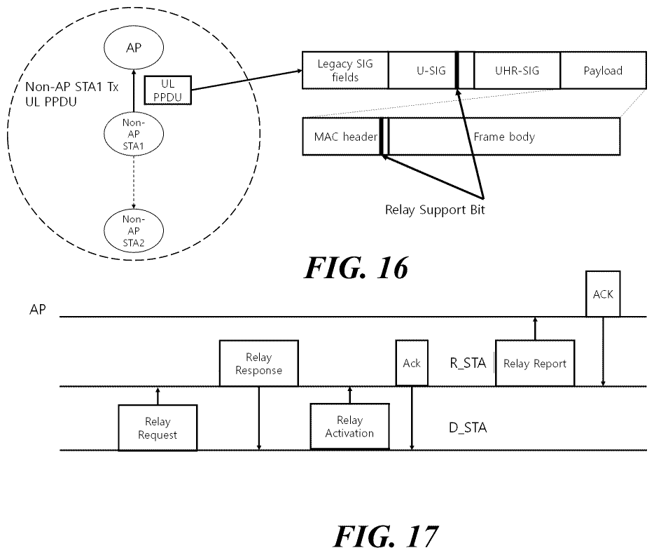

FIG. 16 illustrates a non-AP station searching for a non-AP station operating as a relay station according to an embodiment of the disclosure.

The second non-AP station (non-AP STA2) overhears the UL PPDU transmitted by the first non-AP station (non-AP STA1) to the AP. The second non-AP station (non-AP STA2) determines whether the PPDU is an Intra-BSS PPDU. The second non-AP station (non-AP STA2) determines that the received PPDU is an intra-BSS PPDU. In this case, the second non-AP station (non-AP STA2) may determine whether the first non-AP station (non-AP STA1) supports a relay operation, based on the value of a predesignated field of a signaling field in the physical layer of the PPDU or the value of a predesignated field of the MAC header of the MPDU, according to the embodiments described above. The second non-AP station (non-AP STA2) may request a relay operation with the first non-AP station (non-AP STA1).

### <Relay Setup>

The destination station may attempt to perform relay setup with a non-AP station that is capable of operating as a relay station discovered through the discovery operation described above. The destination station may request the relay setup to the discovered non-AP station. When relay setup between the destination station and the non-AP station is completed, the non-AP station operates as a relay station for the destination station.

The station requesting the relay setup may transmit a request frame requesting the relay setup to the non-AP station. For the convenience of description, the non-AP station transmitting the request frame in the relay setup process is referred to as a relay request station. In this case, the request frame may include information on the relay request station. Specifically, the request frame may include at least one of an AID of the relay request station, TID mapping information agreed (negotiated) between the relay request station and the AP, and a QoS requirement. The TID mapping information may be configured for each transmission direction (UL/DL). In addition, when there is no separately agreed TID mapping between the relay request station and the AP, the request frame may not include TID mapping information.

The non-AP station receiving the request frame may transmit a response frame for the relay setup request to the station requesting the relay setup to accept the relay request. For the convenience of description, the non-AP station that receives the request frame and transmits the response frame is referred to as a relay request response station. The response frame may include information on the capability supported by the relay requesting station in the relay operation. Specifically, the response frame may include at least one of the data rate supported by the relay request response station in the relay operation, the queue size, whether BlockAck is supported, TWT information, and the number of destination stations for which relay setup has already been completed. The data rate may be configured for each transmission direction (UL/DL). In addition, the queue size may be a queue size for the relay operation. In addition, the queue size may be configured in units of bytes. In addition, whether BlockAck is supported may indicate whether the relay operation supports transmitting and receiving BlockAck. In addition, the TWT information may be information on a TWT operated by the relay request response station.

The relay request station may determine whether to complete the relay setup based on the received response frame. Specifically, the relay request station may determine whether to complete the relay setup based on the capability supported by the relay request response station indicated by the received response frame in a relay operation. When the relay request station determines to complete the relay setup, the relay request station may transmit an activation frame for initiating a relay operation to the relay request response station. In addition, when the relay request station determines not to complete the relay setup, the relay request station may search for another station to perform the relay operation or move the BSS.

When the activation frame is received, the relay request station operates as a destination station, and the relay request response station operates as a relay station. The relay station may transmit a report frame including information on the destination station for which the relay station supports a relay operation to the AP. The AP may transmit, to the relay station, an MPDU transmitted to the destination station. The relay station may transmit, to the destination station, the MPDU received from the AP.

The relay station may transmit, to the AP, a report frame including an AID of the destination station for which the relay station supports a relay operation. When the relay station supports the relay operation of multiple destination stations, the relay station may transmit, to an AP, a report frame including the AIDs of the multiple destination stations for which the relay station supports the relay operations.

FIG. 17 illustrates that relay setup is completed and a destination station and a relay station operate in a relay operation according to an embodiment of the disclosure.

In an embodiment of FIG. 17, a second non-AP station (non-AP STA2) discovers a first non-AP station (non-AP STA1) that supports a relay operation through relay discovery. The second non-AP station (non-AP STA2) transmits a request frame (Relay Request) requesting relay setup to the first non-AP station (non-AP STA1). In this case, the request frame (Relay Request) may include information on the second non-AP station (non-AP STA2) as described above. The first non-AP station (non-AP STA1) may determine whether to configure a relay for the second non-AP station (non-AP STA2) based on information on the second non-AP station (non-AP STA2). The first non-AP station (non-AP STA1) determines to configure a relay for the second non-AP station (non-AP STA2) and transmits a relay response frame to the second non-AP station (non-AP STA2). The relay response frame includes the capability supported in the relay operation of the first non-AP station (non-AP STA1). The second non-AP station (non-AP STA2) determines whether to complete the relay setup, based on the capability supported in the relay operation of the first non-AP station (non-AP STA1). The second non-AP station (non-AP STA2) transmits a relay activation frame to the first non-AP station (non-AP STA1) to request the initiation of the relay operation. The first non-AP station (non-AP STA1) that receives the activation frame starts the relay operation. The second non-AP station (non-AP STA2) starts the relay operation. The first non-AP station (non-AP STA1) transmits, to the AP, a report frame including information on the second non-AP station (non-AP STA2). The AP transmits the MPDU transmitted to the second non-AP station (non-AP STA2) to the first non-AP station (non-AP STA1). The first non-AP station (non-AP STA1) transmits the MPDU received from the AP to the second non-AP station (non-AP STA2).

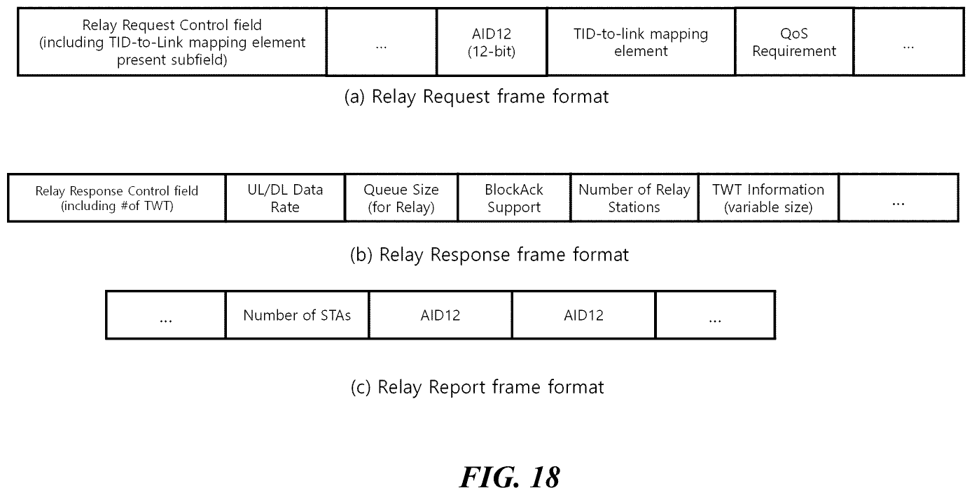

FIG. 18 illustrates a format of a frame exchanged in a relay setup process according to an embodiment of the disclosure.

For the convenience of description, the non-AP station transmitting the request frame in the relay setup process is referred to as a relay request station, and the non-AP station that receives the request frame and transmits the response frame is referred to as a relay request response station.

As described above, the request frame, response frame, and report frame exchanged in the relay setup process may include various pieces of information. The request frame may include a TID-to-link mapping element. In addition, the request frame may include a Relay Request Control field. The Relay Request Control field may include a TID-to-Link mapping element present subfield. The TID-to-Link mapping element present subfield indicates whether the request frame includes a TID-to-Link mapping element. For example, when the request frame includes the TID-to-Link mapping element, the value of the TID-to-Link mapping element present subfield may be configured to 1. In addition, when the requesting station is included in a multi-link device, a TID-to-Link mapping negotiation is performed between the multi-link device and the AP, and the mapping is not the default mapping, the requesting relay station may not be allowed to transmit a request frame that does not include the TID-to-Link mapping element. The request frame may include an AID12 subfield indicating the AID12 of the relay request station. The request frame may include a QoS Requirement subfield that indicates information related to QoS requirements of the relay request station. In this case, the information related to the QoS requirements may indicate a delay (latency) bound or a minimum required data rate. In addition, when it is determined that the non-AP station receiving the request frame cannot support the QoS requirements of the relay requesting station, the non-AP station receiving the request frame may reject the relay setup.

The response frame may include a UL/DL Data Rate subfield indicating a data rate that the relay request response station may provide to the relay request station. In this case, the data rate may be indicated for each transmission direction (UL/DL). In addition, the response frame may include a Queue Size subfield that indicates the size of a queue available for the relay request station by the relay request response station. In addition, the response frame may include a BlockAck Support subfield that indicates whether the relay request station supports BlockAck transmission and reception for the MPDU exchanged in the relay operation. In addition, the response frame may include a Number of Relay Stations subfield that indicates the number of non-AP stations currently supporting the current relay operation by the relay request response station. In addition, the response frame may include a TWT information subfield that indicates information on an individual TWT agreement configured between the responding station and the AP. When the number of individual TWT agreements established between the relay request responding station and the AP is plural, the TWT information subfield may indicate information on each of the multiple individual TWT agreements. In addition, the Relay Response Control field included in the requesting frame may include a field that indicates the number of individual TWT agreements indicated by the TWT information subfield.

The relay requesting station may determine whether to complete the relay setup, based on information indicated by the response frame. Specifically, if the response frame indicates that the relay respond station does not support BlockAck, the relay request station may stop the relay setup. In addition, when the doze state maintenance period of the relay response station's TWT configuration indicated by the response frame is longer than a predesignated time, the relay request station may stop the relay setup. Through these embodiments, the relay request station may determine the expected communication quality when the relay response station performs a relay operation. In addition, the relay request station may determine whether to proceed with relay setup based on the expected communication quality.

As described above, the report frame may indicate information on a newly added destination station to a relay station that has completed relay setup. The report frame may include a Number of STAs subfield that indicates the number of destination stations supporting a relay operation. In addition, the report frame may include an AID12 subfield that indicates the AID12 of the destination station supporting the relay operation by the relay station.

The format of a specific request frame, a response frame, and a report frame may be as shown in FIG. 18.

### <Relay Protocol>

The relay station needs to transmit and receive not only traffic for the destination device but also traffic for the relay station itself. The relay station may experience a decrease in the efficiency of traffic transmission and reception for the relay station due to the relay operation. In addition, the power management efficiency of the relay station may decrease. Therefore, a relay protocol that takes relay stations into consideration is needed to encourage participation of many non-AP stations in the relay operation.

### <Operation of Relay Station>

The relay station needs to determine whether the MPDU received by the relay station is an MPDU for the relay station or an MPDU for the destination station. In this case, the relay station may determine whether the received MPDU is an MPDU for the relay station or an MPDU for the destination station based on the receiver address of the MPDU. The receiver address of the MPDU may be indicated by either the value of the Receiver Address field or the value of the Destination Address field of the MAC header. Specifically, the relay station may operate as follows.

The relay station may identify the receiver address of the received MPDU. In this case, when the receiver address of the received MPDU is the MAC address of the relay station, the relay station may MAC process the received MPDU and forward the same to the upper layer. In addition, when the receiver address of the received MPDU is the MAC address of the destination station, the relay station may queue the received MPDU in a buffer for a relay operation. The relay station may operate a buffer for the relay operation for each destination station. In addition, the relay station may operate a buffer for each of the multiple TIDs for each destination station. In addition, when the received MPDU requests an ACK/BA, the relay station may transmit an ACK/BA for the received MPDU. In this case, the relay station may transmit the ACK/BA regardless of the receiver address of the received MPDU. When the relay station is allocated a resource for transmitting the PPDU to the destination station, the relay station may transmit the MPDU queued in the buffer for the relay operation to the destination station. In this case, the resource for transmitting the PPDU to the destination station may include at least one of time, such as a TXOP, and a resource unit (RU) allocated for transmission. When transmission to the destination station of the relay station fails, the relay station may retransmit the MPDU for which the transmission failed. When the transmission to the destination station of the relay station is successful, the relay station may delete the successfully transmitted MPDU from the buffer for the relay operation.

The relay station may transmit the broadcast frame received from the AP to the destination station. In this case, the broadcast frame may be a group addressed frame. Specifically, the relay station may transmit a non-individually addressed MPDU to the destination station rather than an individual address by using the relay PPDU. Through this, the notification of the AP may be delivered to the destination station. In addition, the relay station may select information to be delivered to the destination station from information notified by the AP and transmit the selected information to the destination station. In a specific embodiment, when the AP indicates critical update information by using a beacon frame, the relay station may transmit the relay PPDU including an element corresponding to the critical update to the destination station. For example, when the AP indicates a critical update to change the EDCA parameter by using a beacon frame, the relay station may transmit the relay PPDU including information on the EDCA parameter to the destination station. In addition, when the AP transmits a Channel Switch Announcement element, the relay station may transmit information generated based on the Channel Switch Announcement element to the destination station. This may ensure a channel switch of the destination station.

### <Resource Allocation for Relay Station>

The relay station needs to be allocated resources to exchange MPDUs for the relay station as well as resources to exchange MPDUs for the destination station. When the relay station exchanges MPDUs for a relay operation by using the obtained TXOP and frequency resources, processing of the MPDU exchange for the relay station may be delayed. Therefore, the non-AP station is likely to not participate as a relay station in the relay operation.

The AP may allocate resources for a relay operation to the relay station. Specifically, the AP may allocate a TXOP for the relay operation to the relay station within the TXOP obtained by the AP. The relay station may perform the relay operation within the TXOP allocated by the AP for the relay operation. The AP may allocate a TXOP for the relay operation to the relay station by using an MU-RTS TXS trigger frame. The MU-RTS TXS trigger frame may indicate the time duration allocated by the MU-RTS TXS trigger frame and the station to which the TXOP is allocated.

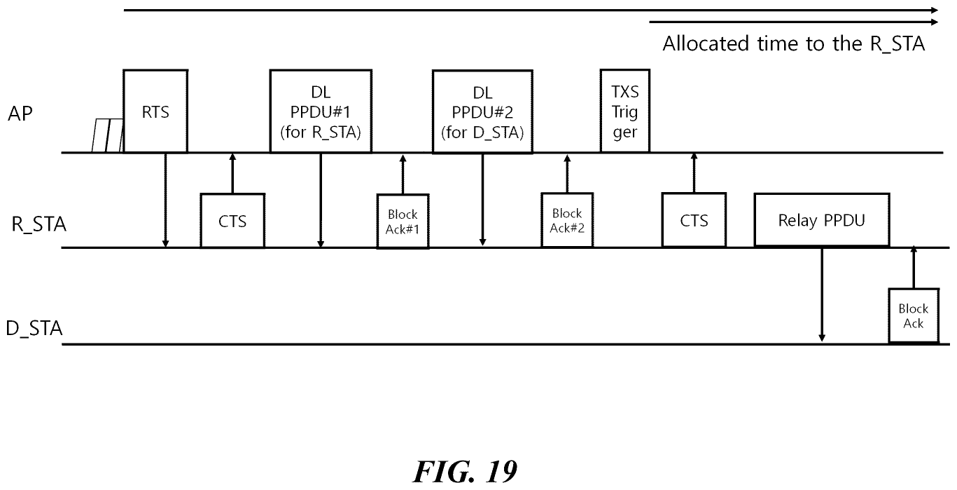

FIG. 19 illustrates performing a relay operation within a TXOP allocated by an AP according to an embodiment of the disclosure.

The AP transmits a first PPDU (DL PPDU #1) to the relay station after obtaining the TXOP. The first PPDU (DL PPDU #1) is a PPDU including an MPDU having the relay station as a destination device. The relay station receives the first PPDU (DL PPDU #1) and transmits a first BlockAck (BlockAck #1). The AP receives the first BlockAck (BlockAck #1) from the relay station and transmits a second PPDU (DL PPDU #2). The second PPDU (DL PPDU #2) is a PPDU including an MPDU having the destination device as a destination station. The relay station receives the second PPDU (DL PPDU #2) and transmits a second BlockAck (BlockAck #2) that indicates whether reception of the MPDU included in the second PPDU (DL PPDU #2) is successful to the AP. In this case, the AP may delete the MPDU (MSDU) indicated as having received the second BlockAck (BlockAck #2) from the queue

The AP receives the second BlockAck (BlockAck #2) from the relay station and allocates the TXOP for the relay operation to the relay station within the TXOP obtained by the AP. Specifically, the AP allocates the TXOP for the relay operation to the relay station using the TXS trigger frame. The relay station receiving the TXS trigger frame transmits a CTS frame to the AP as a response to the TXS trigger frame. The relay station transmits the relay PPDU to the destination station within the allocated TXOP. The destination station transmits a response frame that indicates whether an MPDU (MSDU) included in the relay PPDU is received to the relay station. In this case, the response frame may be a BlockAck or an ACK frame. When the relay station determines that the transmission of the MPDU (MSDU) included in the relay PPDU has failed, the relay station may perform a MAC-layer recovery operation. Specifically, the relay station may perform retransmission of the MPDU (MSDU) for which transmission has failed.

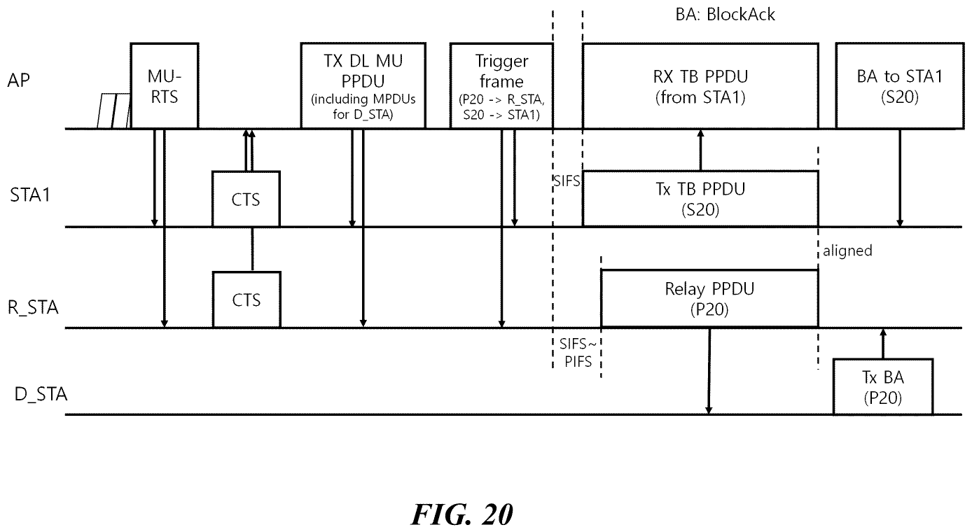

The AP may allocate an RU to be used for a relay operation to the relay station by using a trigger frame. This is described with reference to FIG. 20.

FIG. 20 illustrates an AP allocating an RU to a relay station and the relay station performing a relay operation in the allocated RU according to an embodiment of the disclosure.

The relay station may transmit a relay PPDU to the destination station in the RU allocated for a relay operation in the trigger frame. In this case, the format of the relay PPDU may not be a TB PPDU. The trigger frame may allocate an RU for the relay operation and an RU for a UL transmission together. For example, the trigger frame may allocate a 242-tone RU in a primary 20 MHz band as an RU for RU operation to the relay station, a 242-tone RU in a secondary 20 MHz band to the first station, and a 484-tone RU in a 40 MHz band to the second station. In addition, the relay station may transmit the relay PPDU at the same time as the TB PPDU transmission of the station having been allocated the RU through the trigger frame that has allocated the RU to the relay station. In this case, the relay station and the station allocated with an RU through the trigger frame may use orthogonal frequency division multiple access (OFDMA). In addition, the end time of the relay PPDU may be limited to be the same as or earlier than the end time of the TB PPDU.

In addition, the trigger frame may indicate the purpose to which the RU is allocated. Specifically, the trigger frame may indicate that an RU allocated for a relay operation is allocated. For example, the trigger frame may include an indicator that indicates that the RU is allocated for the relay operation. In addition, when the AP transmits an MPDU to be transmitted to the destination station to the relay station and then transmits a trigger frame immediately afterwards or within a predesignated time, the RU indicated by the trigger frame may be implicitly indicated as an RU allocated for the relay operation.

The AP may perform spatial reuse (SR) for the RU allocated to the relay station for a relay operation. Specifically, the AP may transmit a PPDU to a station that is a hidden station of the relay station in the RU allocated to the relay station for the relay operation. In this case, the station corresponding to the hidden station of the relay station may receive the DL PPDU without being affected by the interference caused by the relay PPDU transmission of the relay station. In this embodiment, the length of the DL PPDU transmitted by the AP may be limited to within the length of the relay PPDU transmitted by the relay station. Specifically, the length of the DL PPDU may be the same as the length of the relay PPDU. In this case, the end time of the relay PPDU and the end time of the DL PPDU may be a time point aligned with the length indicated by the UL Length field of the trigger frame, i.e., a time point at which the PPDU indicated by the UL Length field ends at an SIFS. In addition, the AP may configure the interval between the trigger frame and the DL PPDU to a PCF inter-frame space (PIFS). This may ensure that the relay PPDU is transmitted before the DL PPDU. In order to implement this embodiment, a procedure for hidden station identification may be performed. The AP may allow the non-AP station of the BSS operated by the AP to transmit a response indicating whether the frame transmitted by the relay station has been received. The AP may determine a station that does not receive the frame transmitted by the relay station as a hidden station.

The relay station may transmit the relay PPDU at intervals within a predesignated time period after receiving the trigger frame. In this case, the predesignated time period may be equal to or greater than a short inter-frame space (SIFS) and less than a PIFS. The station receiving the trigger frame transmits the response frame in the SIFS interval, but this is because the relay PPDU is a PPDU transmitted to the destination station other than the AP.

In an embodiment of FIG. 20, the AP transmits an MU-RTS frame. The first STA (STA1) and the relay station (R_STA) transmit CTS frames in response to the MU-RTS frame. The AP transmits a DL MU PPDU to the first station (STA1) and the relay station (R_STA). The DL MU PPDU includes an MPDU to be transmitted by the relay station (R_STA) to the destination station (D_STA). The AP transmits a trigger frame for allocating an RU to the first station (STA1) and the relay station (R_STA). In this case, the trigger frame allocates a 242-tone RU of the primary 20-MHz channel to the relay station (R_STA) as an RU for a relay operation. In addition, the trigger frame allocates a 484-tone RU of the secondary 40 MHz band to the first station (STA1). The relay station transmits the relay PPDU to the destination station in the 242-tone RU of the allocated primary 20 MHz channel. The first station (STA1) transmits a PPDU (TX TB PPDU) to the AP in the 484-tone RU in the secondary 40 MHz band. The relay station STA1 starts transmitting the relay PPDU after the first station STA1 starts transmitting the PPDU (TX TB PPDU). As described in the above embodiments, the relay station (R_STA) may determine the interval between the trigger frame and the relay PPDU within a predesignated time period. The predesignated time period may be SIFS or more and PIFS or less. The end time of the relay PPDU may be the time indicated by the UL Length field of the trigger frame, that is, the time when the PPDU of the length indicated by the UL Length field is terminated at SIFS.

However, the relay PPDU ends at a time (the time indicated by the UL Length field included in the trigger frame) indicated through the trigger frame. That is, the relay PPDU ends at the same time as the TB PPDU that has been responded to together.

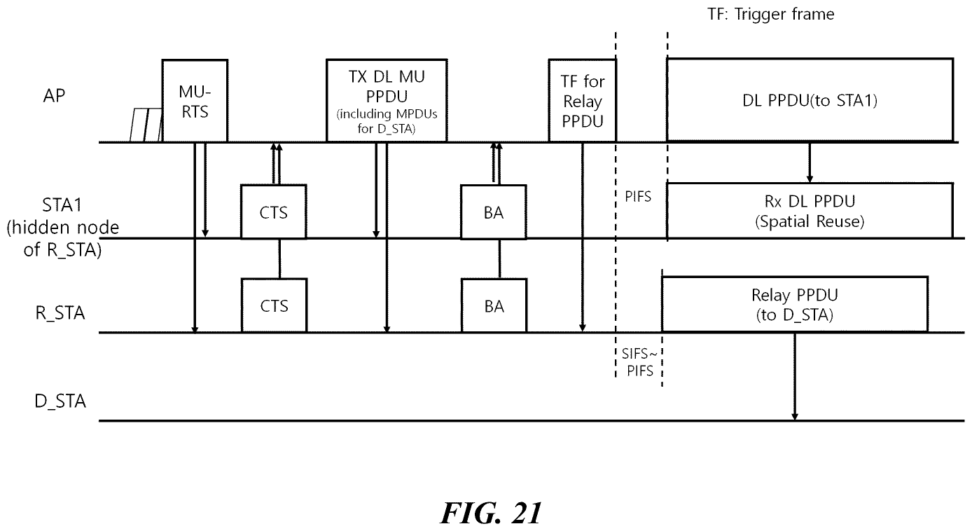

FIG. 21 illustrates an SR operation performed in an RU allocated to a relay station by an AP according to an embodiment of the disclosure.

The operations up to the trigger frame transmission in FIG. 21 are the same as those in FIG. 20. However, in FIG. 21, the AP transmits DL PPDUs to the relay station and the first station (STA1) that is a hidden station while the relay PPDU is being transmitted. In this case, the interval between the trigger frame and the DL PPDU is PIFS as described above.

### <Constraints on Relay Operation>

When the AP performs a transmission to the relay station to transmit an MPDU to the destination device, the transmission may be performed depending on the physical layer capability of the relay station. This is because the relay station, not the destination station, performs the direct reception. In addition, the AP may configure an MPDU transmitted to the destination station based on a MAC layer capability of the relay station. Specifically, the AP may configure an MPDU transmitted to the destination station based not only on the MAC layer capability of the destination station but also on the MAC layer capability of the relay station. Therefore, the AP may configure an MPDU to be transmitted to the relay station based on the minimum supported function among the MAC layer capabilities of the destination station and the MAC layer capabilities of the relay station. In addition, the relay station may configure the MPDU transmitted to the AP based on the MAC layer capability of the relay station. Specifically, the relay station may configure an MPDU transmitted to the AP depending on not only the MAC layer capability of the AP but also the MAC layer capability of the relay station. Therefore, the destination station may configure an MPDU to be transmitted to the relay station depending on the minimum supported capability among the MAC layer capability of the AP and the MAC layer capability of the relay station. Specifically, the capability regarding the MAC layer of the relay station may include at least one of the maximum number of MSDUs that may be included in an A-MSDU, whether to support Multi-TID A-MPDUs, the capability for fragmentation, whether to support All Ack, the maximum value of extension of the A-MPDU length, and whether to support ACKs other than BA frames for A-MSDUs. The capability regarding fragmentation may include at least one of whether to support dynamic fragmentation, the maximum number of fragmented MSDUs/A-MSDUs, and the maximum value of the fragment. For example, the AP and the destination station may support a Multi-TID A-MPDU, but the relay station may support only a Single-TID A-MPDU. In this case, the AP and the destination station may not be allowed to configure an A-MPDU having multiple TIDs and perform frame exchange with the relay station. In addition, when the destination device supports an A-MPDU having four TIDs but the relay station supports an A-MPDU having two TIDs, the AP cannot configure an A-MPDU transmitted to the relay station to have more than three TIDs for transmission to the destination device.

Through these embodiments, the non-AP station operating as a relay station may prevent problems that may occur due to the limited capabilities compared to the AP. This is because, when generating and transmitting the MPDU considering only the capabilities of the AP and the destination station, the relay station may be burdened or the relay operation may not be executed. In addition, through these embodiments, the processing burden on the MAC layer of the relay station may be reduced.

### <Relay PPDU for Multiple Stations>

The relay PPDU may include an MPDU transmitted to multiple stations. Specifically, the relay PPDU may be a multiuser (MU) PPDU. In addition, the relay PPDU may transmit the MPDU to multiple stations according to an RU allocated to each of the multiple stations. In addition, the relay PPDU may be transmitted by using MU-MIMO or OFDMA. In addition, the relay PPDU may indicate information on the frequency domain, for example, RU, in which the MPDU is transmitted that each station should receive. In this case, the information on the RU may include at least one of the position of the RU and RU allocation information. In addition, the information on the frequency domain may be included in the preamble of the relay PPDU, for example, in a UHR signaling field. Multiple stations may determine the frequency domain in which the MPDU for each of the multiple stations is transmitted based on the preamble of the relay PPDU. In addition, the preamble of the relay PPDU may be repeated in units of 20 MHz. In this case, the station receiving the relay PPDU may identify a preamble of one of the 20 MHz bands and determine a frequency domain in which an MPDU for the station is transmitted. In addition, the relay PPDU may include information indicating the frequency domain in which the MPDU for the station is transmitted, even if the relay PPDU includes only the MPDU for one station.

In addition, the multiple stations may include not only a destination station but also a station that is not a destination station. Specifically, the multiple stations may include not only the destination station but also an AP.

In addition, the relay station may exchange an MU-RTS frame and a CTS frame before transmitting a PPDU including an MPDU transmitted to multiple stations.

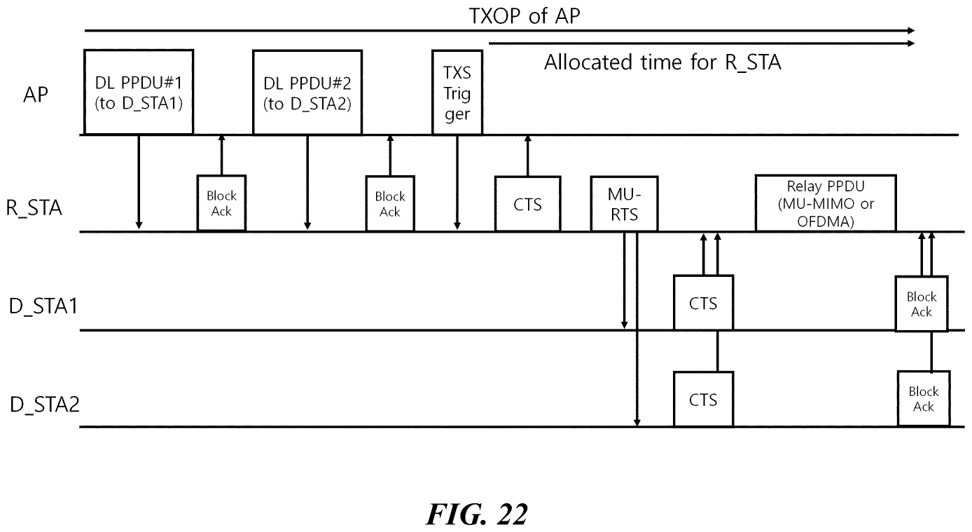

FIG. 22 illustrates an operation of a relay station transmitting a relay PPDU for multiple destination stations according to an embodiment of the disclosure.

In an embodiment of FIG. 22, the AP transmits a first DL PPDU (DL PPDU #1) including an MPDU transmitted to the first destination station (D_STA1) to the relay station (R_STA). The relay station transmits a block ACK for the first DL PPDU (DL PPDU #1) to the AP. The AP transmits a second DL PPDU (DL PPDU #2) including an MPDU transmitted to the second destination station (D_STA2) to the relay station (R_STA). The relay station transmits a block ack for the second DL PPDU (DL PPDU #2) to the AP. In this case, the relay station may determine which destination station the MPDU needs to be transmitted to, based on the receiver address field of the MPDU. The AP allocates a TXOP to the relay station (R_STA) by transmitting a TXS trigger frame (TXS Trigger). The relay station (R_STA) transmits a CTS frame to the AP in response to the TXS trigger frame (TXS Trigger).

The relay station (R_STA) exchanges the MU-RTS frame and CTS frame with the first destination station (D_STA1) and the second destination station (D_STA2) within the allocated TXOP. The relay station (R_STA) transmits a relay PPDU including a PPDU transmitted to the first destination station (D_STA1) and the second destination station (D_STA2) by using MU-MIMO or OFDMA. The first destination station (D_STA1) and the second destination station (D_STA2) transmit a Block Ack frame to the relay station (R_STA).

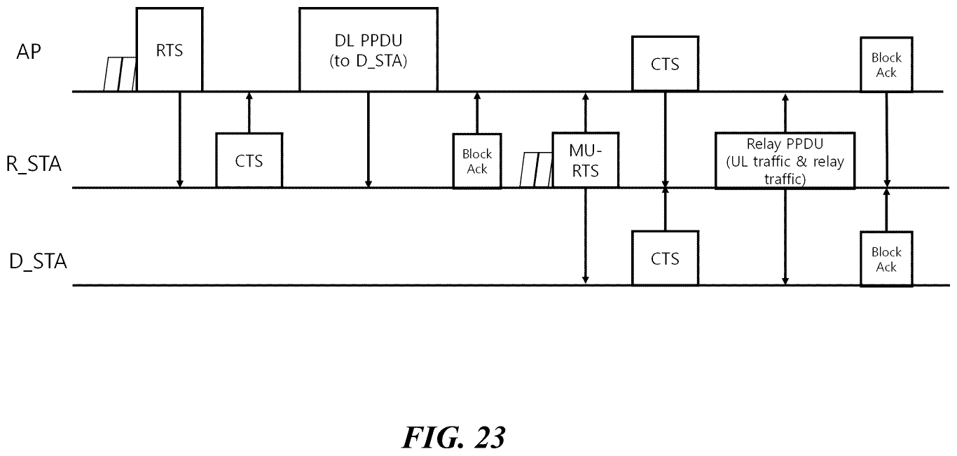

FIG. 23 illustrates an operation of transmitting a relay PPDU including both an MPDU transmitted by a relay station to an AP and an MPDU transmitted by the relay station to a destination station according to an embodiment of the disclosure.

In FIG. 23, the AP and the relay station (R_STA) exchange an RTS frame and a CTS frame. The AP transmits a DL PPDU to the relay station (R_STA). The relay station (R_STA) transmits a block ACK. The relay station (R_STA) exchanges an MU-RTS frame and a CTS frame with the AP and the destination station (D_STA). The relay station (R_STA) transmits a relay PPDU including an MPDU to be transmitted to the AP and an MPDU to be transmitted to the destination station (D_STA) to the AP and the destination station (D_STA). The relay PPDU indicates an RU in which the MPDU transmitted to the destination station (D_STA) is transmitted and an RU in which the MPDU transmitted to the AP is transmitted. The AP and the destination station receive the MPDUs transmitted to the AP and the destination station, respectively, according to the RU indicated by the relay PPDU.

When the relay station transmits a UL PPDU to transmit the MPDU received from the destination station, the relay station may include the MPDU that the relay station transmits to the AP in the UL PPDU. In this case, the UL PPDU includes an MPDU including traffic received from the destination station and an MPDU including traffic transmitted by the relay station to the AP. In addition, the UL PPDU may include information indicating a frequency resource to which the MPDU is transmitted for each transmission station. Specifically, the UHR-SIG field of the UL PPDU may include information indicating resources in which an MPDU is transmitted for each station. In this case, the frequency resource may be an RU. The AP may determine which station has transmitted the MPDU included in the UL PPDU, based on information indicating the resource in which the MPDU is transmitted for each station.

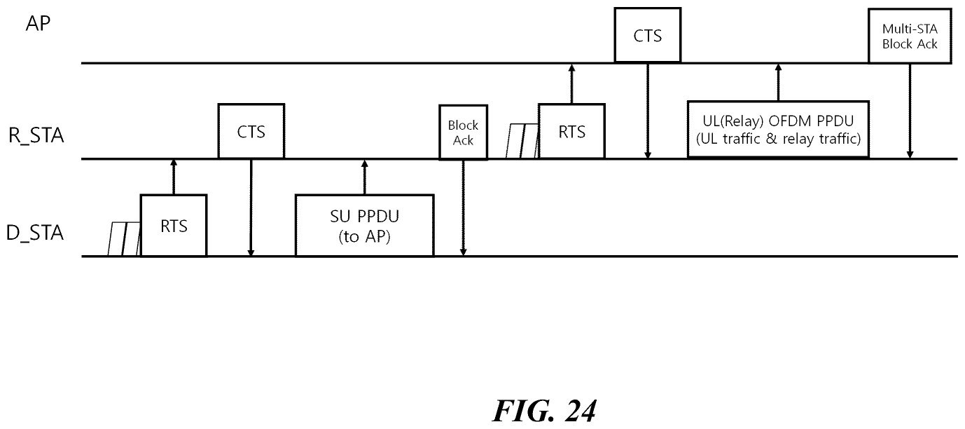

FIG. 24 illustrates that when a relay station transmits a UL PPDU to transmit an MPDU received from a destination station, the UL PPDU includes an MPDU transmitted by the relay station to an AP according to an embodiment of the disclosure.

The destination station (D_STA) exchanges an RTS frame and a CTS frame with the relay station (R_STA). The destination station (D_STA) transmits an SU PPDU including an MPDU to be transmitted to the AP to the relay station (R_STA). The relay station (R_STA) transmits a BlockAck to the destination station (D_STA). The relay station (R_STA) exchanges an RTS frame and a CTS frame with the AP. The relay station (R_STA) transmits an UL PPDU including an MPDU transmitted by the destination station (D_STA) to the AP and an MPDU transmitted by the relay station (R_STA) to the AP. The AP receives the MPDU transmitted from the destination station (D_STA) included in the UL PPDU and the MPDU transmitted from the relay station (R_STA) to the AP. The AP transmits a Multi-STA BlockAck frame to the relay station (R_STA), which indicates whether the MPDU transmitted from the destination station (D_STA) to the AP and the MPDU transmitted from the relay station (R_STA) to the AP are successful, respectively. The multi-STA BlockAck frame includes a per AID TID Info field corresponding to the relay station and a per AID TID Info field corresponding to the destination station. In this case, the value of the AID11 subfield of the Per AID TID Info field corresponding to the relay station (R_STA) is the AID11 of the relay station (R_STA). AID11 indicates the 11-bit value among the AID values. The value of the AID11 subfield in the Per AID TID Info field corresponding to the destination station (D_STA) is the AID11 of the destination station (D_STA).

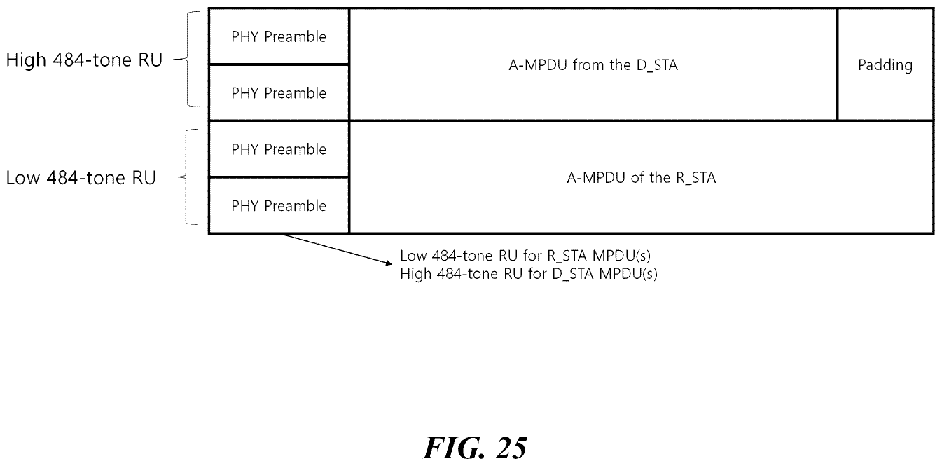

FIG. 25 illustrates a format of a UL PPDU including an MPDU received by a relay station from a destination station and an MPDU transmitted by the relay station to an AP according to an embodiment of the disclosure.

As described above, the relay station may transmit an MPDU including traffic received from the destination station together with an MPDU including traffic transmitted to the AP. The relay station may generate a first A-MPDU by aggregating the MPDUs including the traffic received from the destination station. In addition, the relay station may aggregate MPDUs including traffic transmitted from the relay station to the AP to configure a second A-MPDU. The relay station may transmit the first A-MPDU and the second A-MPDU by using one PPDU. In this case, the PPDU may be transmitted using OFDM. The first A-MPDU and the second A-MPDU may have the same length. In addition, when the lengths of the first A-MPDU and the second A-MPDU are different, the first A-MPDU or the second A-MPDU may include padding so that the first A-MPDU and the second A-MPDU have the same length. The first A-MPDU and the second A-MPDU may be transmitted through independent frequency resources through OFDM, for example, an RU. In this case, information on the frequency resources to which the first A-MPDU and the second A-MPDU are transmitted may be indicated in the UHR-SIG field of the UL PPDU.

In an embodiment of FIG. 25, the first A-MPDU is transmitted through a 40 MHz band corresponding to a Low 484-tone RU area, and the second A-MPDU is transmitted through a 40 MHz band corresponding to a High 484-tone RU area. In this case, the information on the frequency resource is indicated identically for every 20 MHz band in the preamble of the physical layer.

### <BlockAck Frame Format for Relay Operation>

The relay station may transmit a BlockAck to the AP. Specifically, the relay station may transmit the BlockAck that indicates whether the relay station has received an MPDU (MSDU) transmitted by the AP and whether the AP has received an MPDU (MSDU) transmitted to the destination station of the AP.

The AP may transmit the BlockAck that indicates whether the AP has received the MPDU (MSDU) transmitted by the relay station to the AP and whether the AP has received the MPDU (MSDU) transmitted by the destination station to the AP. Specifically, when the relay station transmits an UL PPDU that includes the MPDU (MSDU) transmitted by the relay station to the AP and an MPDU (MSDU) transmitted by the destination station to the AP, the AP may transmit the BlockAck that indicates whether the MPDU (MSDU) transmitted by the relay station to the AP and the MPDU (MSDU) transmitted by the destination station to the AP are received, to the relay station.

Such a BlockAck may be transmitted as a Multi-STA BlockAck frame. In this case, the value of the AID11 subfield of the Per AID TID Info subfield indicating whether the MPDU (MSDU) transmitted by the destination station to the AP has been received in the Multi-STA BlockAck frame may indicate the AID11 of the destination station.

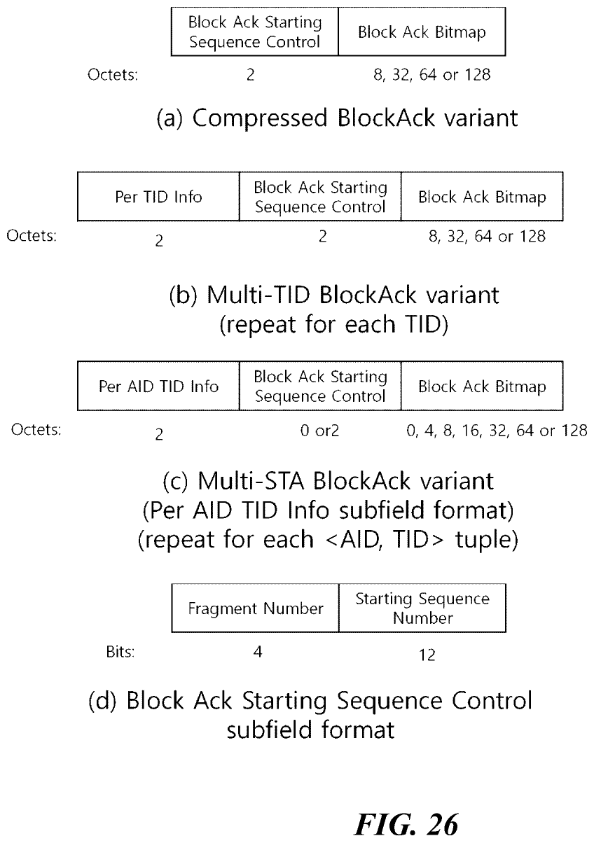

FIG. 26 illustrates the format of a generally used BlockAck frame.

(a) of FIG. 26 illustrates a BA information field format when the type of the BA indicated in the BA Control field is indicated as a compressed BlockAck.

The compressed BlockAck variant format of the BA information field is composed of a 2-octet Block Ack Starting Sequence Control subfield and an 8/32/64/128-octet Block Ack Bitmap subfield. Since the Block Ack Bitmap subfield has a maximum size of 128 octets, it is a size that may indicate compressed BAs for up to 1024 MPDUs. The device capable of using a 64/128-octet Block Ack Bitmap subfield may be limited to an EHT/UHR device or a subsequent generation device of UHR capable of responding/receiving 512/1024-bit BA. Since the length of the Block Ack Bitmap subfield may be configured to have various lengths, a device receiving the BlockAck frame must know the size of the Block Ack Bitmap subfield included in the BlockAck frame in order to interpret the BlockAck frame. Information related to the size of the Block Ack Bitmap subfield is indicated together with the SSN in the Block Ack Starting Sequence Control subfield before the Block Ack Bitmap subfield.

(d) of FIG. 26 illustrates the format of a Block Ack Starting Sequence Control subfield, and a Block Ack Starting Sequence Control subfield having a 2-octet size may be composed of a 4-bit Fragment Number subfield and a 12-bit Starting Sequence Number subfield. As illustrated in (a), (b), and (c) of FIG. 26, the Block Ack Starting Sequence Control subfield may be commonly included in the BA Information field of various BlockAck variants. In the format of the BA Information field of the Multi-STA BlockAck variant of (c) of FIG. 26, the Block Ack Starting Sequence Control subfield may be omitted if a specific condition is satisfied. In this case, when the Block Ack Starting Sequence Control subfield is omitted, the Block Ack Bitmap subfield may also be omitted.

The length of the Block Ack Bitmap subfield is indicated by the Fragment Number subfield composed of 4 bits, and the device having received the BA may determine the size of the Block Ack Bitmap subfield and determine information indicated by the bitmap, based on the information indicated by the Fragment Number subfield.

Depending on the type of TID included in the BlockAck frame and the number of AID-TID, the BlockAck frame may include a plurality of multi-TID BlockAck variants and multi-TID BlockAck variants as shown in (b) and (c) of FIG. 26.

The Per TID Info field of (b) of FIG. 26 includes a TID subfield indicating which TID each Multi-TID BlockAck variant corresponds to. When the TID subfields of the two Multi-TID BlockAck variants transmitted to a specific STA indicate 0 and 1, the Multi-TID BlockAck frame received by the corresponding station indicates whether MPDUs corresponding to TID 0 and TID 1 are successfully received.

The Per AID TID Info field in (c) of FIG. 26 includes an AID11 subfield indicating which station each Multi-STA BlockAck variant is for. The Per AID TID Info field includes a TID subfield indicating which TID each Multi-STA BlockAck variant is for the MPDU (MSDU). The <AID11 subfield, TID subfield> of the four Multi-STA BlockAck variants transmitted to the first station and the second station may each include <AID11 of the first STA, 0>, <AID11 of the first STA, 1>, <AID11 of the second STA, 2>, and <AID11 of the second STA, 3>. In this case, the Multi-STA BlockAck frame indicates whether the MPDUs with a TID of 0 or 1 among the MPDUs transmitted by the first STA have been successfully received and whether the MPDUs with a TID 2 or 3 among the MPDUs transmitted by the second STA have been successfully received.

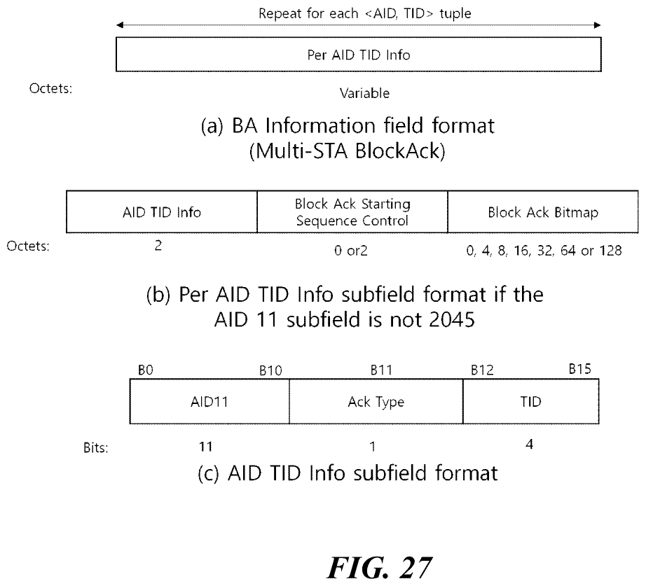

FIG. 27 illustrates a format of a general multi-STA BlockAck frame.

(a) of FIG. 27 illustrates a format of a BA Information field, (b) of FIG. 27 illustrates a format of a Per AID TID Info subfield included in the BA Information field, and (c) of FIG. 27 illustrates a format of an AID TID Info subfield included in the Per AID TID Info subfield. The BA Information field of the Multi-STA BlockAck frame includes a Per AID TID Info subfield for each combination of an AID and a TID. As shown in (b) of FIG. 27, the Per AID TID Info subfield includes each AID TID Info subfield. The AID TID Info subfield indicates the structure of the Per AID TID Info subfield including the AID TID Info subfield and the identifier of the station corresponding to the Per AID TID Info subfield, for example, the AID and the TID corresponding to the Per AID TID Info subfield. The station receiving the Multi-STA BlockAck may determine that the Per AID TID Info subfield including the AID TID Info subfield including an AID11 subfield indicating the AID11 of the station is information for the station.

Each of the multiple Per AID TID Info subfields included in the Multi-STA BlockAck frame may include information corresponding to a different station. The station receiving the multi-STA BlockAck may selectively obtain information indicated by the Per AID TID Info subfield that includes the AID11 subfield indicating the AID of the station, among multiple Per AID TID Info subfields included in the BA Information field. The station may determine whether it has received an MPDU indicated by the Block Ack Bitmap subfield of the BA Information field of the Per AID TID Info subfield, which includes the AID11 subfield indicating the AID of the station.

The station receiving the Multi-STA BlockAck frame may obtain the Per AID TID Info subfield including the AID11 subfield indicating the AID of the station, and update the state of the MPDU of the transmission buffer of the station based on the Block Ack Bitmap subfield included in the obtained Per AID TID Info subfield. In addition, the station receiving the Multi-STA BlockAck frame may not determine the information indicated by the Per AID TID Info subfield including the AID11 subfield that does not indicate the AID of the station. The station receiving the Multi-STA BlockAck frame may determine, based on the length of the Block Ack Bitmap subfield indicated by the Fragment Number subfield, information related to the starting position of the next Per AID TID Info subfield in the Multi-STA BlockAck frame. In this case, the station may determine the position of the AID11 subfield of the following Per AID TID Info subfield in the Multi-STA BlockAck frame based on the length of the Block Ack Bitmap subfield indicated by the Fragment Number subfield. The station receiving the Multi-STA BlockAck frame may determine in turn whether multiple Per AID TID Info subfields included in the Multi-STA BlockAck frame indicate the AID of the station.

As described above, the AP may transmit, to the relay station, a BlockAck frame indicating whether the AP has received an MPDU (MSDU) including traffic of the relay station and an MPDU (MSDU) including traffic of the destination station. The relay station may obtain not only information indicated by the Per AID TID Info subfield corresponding to the AID of the relay station, but also information indicated by the Per AID TID Info subfield corresponding to the AID of a destination station supporting a relay operation. The relay station may determine whether the value of the AID11 subfield included in the Per AID TID Info field indicates the AID11 of the relay station or the AID11 of the destination station supporting the relay operation. The relay station may delete the MPDU (MSDU) from the transmission buffer depending on whether the MPDU (MSDU) indicated by the Per AID TID Info field corresponding to the AID of the relay station is received, and may perform retransmission of the MPDU (MSDU) that has not been received. The relay station may delete the received MPDU (MSDU) from the buffer for the relay operation and perform retransmission of the MPDU (MSDU) that is not received, depending on whether the MPDU (MSDU) indicated by the Per AID TID Info field corresponding to the AID of the destination station has been received.

The AP may transmit an ACK frame in response to the MPDU (MSDU) including the traffic of the relay station and the MPDU (MSDU) including the traffic of the destination station. The AP may respond with an ACK frame to the UL PPDU including the MPDU (MSDU) including the traffic of the relay station and the MPDU (MSDU) including the traffic of the destination station. In a specific embodiment, when the AP successfully receives all the MPDUs (MSDUs) from the UL PPDU including the MPDU (MSDU) including the traffic of the relay station and the MPDU (MSDU) including the traffic of the destination station, the AP may respond with the ACK frame to the UL PPDU. In this case, the ACK frame indicates that all MPDUs (MSDUs) included in the UL PPDU have been successfully received.

In addition, the relay station may transmit, to the AP, a Multi-STA BlockAck frame indicating whether the MPDU (MSDU) received from the AP has been received by distinguishing between the MPDU (MSDU) including traffic for the relay station and the MPDU (MSDU) including traffic for the destination station. Specifically, the Multi-STA BlockAck frame may use a separate Per AID TID Info field to indicate whether the MPDU (MSDU) including traffic for the relay station has been received and whether the MPDU (MSDU) including traffic for the destination station has been received. In this case, when the relay station performs the relay operation for multiple destination stations, the Multi-STA BlockAck frame may distinguish and indicate whether the MPDU (MSDU) including traffic for each of the multiple destination stations has been received. In this case, the Multi-STA BlockAck frame may indicate whether the MPDU (MSDU) including traffic for multiple destination stations is received by using the Per AID TID Info field corresponding to each of the multiple destination stations.

In these embodiments, the station that receives the Multi-STA BlockAck frame is distinguished from the use of the conventional Multi-STA BlockAck frame, which is used by the AP to indicate to multiple stations whether the MPDU (MSDU) has been received. In this case, the value of the AID11 subfield in the Per AID TID Info field corresponding to the destination station may be the AID11 of the destination station. In addition, the value of the AID11 subfield in the Per AID TID Info field corresponding to the relay station may be the AID11 of the relay station or a predesignated value.

In the above-described embodiments, the success or failure of reception of an individual MPDU may be indicated by the value of the sequence number of each MPDU (MSDU) in the Block ACK Bitmap included in the Per AID TID Info field. Specifically, a bit having a 1 in the Block ACK Bitmap may indicate that the reception of the MPDU (MSDU) having a sequence number corresponding to the bit is successful. In addition, a bit having 0 in the Block ACK Bitmap indicates that the reception of the MPDU (MSDU) having a sequence number corresponding to the bit has failed or has not been received.

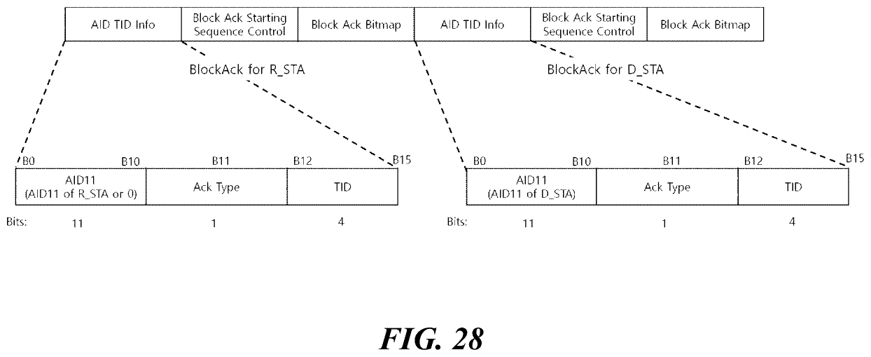

FIG. 28 illustrates a format of a Multi-STA BlockAck frame transmitted by a relay station according to an embodiment of the disclosure.

As described above, the Multi-STA BlockACK frame includes multiple BA Information fields. In an embodiment of FIG. 28, the AID11 field included in the first BA Information field indicates an AID11 of the relay station (R_STA) or a predesignated value of 0 for the relay station (R_STA). Therefore, the first BA Information field corresponds to the TID indicated by the TID field included in the BA Information field, and indicates whether reception of an MPDU including traffic for the relay station (R_STA) is successful. The AID11 field included in the second BA Information field indicates the AID11 value of the destination station (D_STA). Therefore, the second BA Information field corresponds to the TID indicated by the TID field included in the BA Information field, and indicates whether reception of an MPDU including traffic for a destination station (D_STA) is successful.

In the embodiments described above, the reception status may indicate whether reception is successful.

### <Channel Access Method for Uplink Transmission Relay>

The relay station may receive traffic from the destination station, and the relay station may transmit the traffic received from the destination station to the AP. This is referred to as uplink transmission relay. The relay station may perform channel access to perform uplink transmission relay. For the relay station to perform a separate channel access to perform uplink transmission relay is burdensome to the relay station and may harm fairness between the relay station and the destination station. A method for ensuring channel access of the relay station performing relay uplink transmission is required.

The AP may cause the relay station to perform uplink transmission relay on a TXOP obtained by the AP. Specifically, the AP may transmit a trigger frame to the relay station to trigger transmission for uplink transmission relay of the relay station. In addition, the AP may share the TXOP obtained by the AP, and the relay station may perform transmission for uplink transmission relay in the shared TXOP. However, the AP does not know information related to traffic that the destination station is to transmit. The destination station may transmit, in advance, information on traffic to be transmitted through the relay station to the AP. In another specific embodiment, the destination station may transmit, in advance, information on traffic transmitted through the relay station to the AP. In the above-described embodiments, the information related to traffic may be the amount of traffic or the type of traffic. In addition, the destination station may transmit information on traffic to the AP directly. In this case, the destination station and the AP may directly exchange frames with a relatively low data rate. In another specific embodiment, the destination station may transmit information on traffic to the AP through the relay station. In the above-described embodiments, the AP may determine a resource to be allocated to the relay station based on information on traffic. Specifically, the AP may determine the amount of resources to be allocated to the relay station based on information about traffic. For example, the AP may determine at least one of the size of the RU to be allocated to the relay station and the length of the TXOP, based on information on traffic.

In another specific embodiment, within the TXOP obtained by the destination station, the relay station may transmit traffic received from the destination station to the AP. Specifically, the destination station may allocate the TXOP obtained by the destination station to the relay station. Within the allocated TXOP, the relay station may transmit traffic received from the destination station to the AP. As described above, when the AP is to transmit traffic to the destination station through the relay station, the AP may share the TXOP with the relay station. When the destination station is to transmit traffic to the AP through the relay station, the destination station may share the TXOP with the relay station. The allocation of the TXOP by the destination station to the relay station may implicitly indicate that the destination station intends to perform uplink transmission relay. In addition, after transmitting traffic to be transmitted to the destination station, the transmission station may allocate the TXOP obtained by the transmission station to the relay station. The transmission station is a station that transmits traffic through the relay station. The transmission station may be a non-AP station or the AP may be a relay station. In this case, allocation of the TXOP may implicitly indicate relay transmission as described above. In addition, the relay station may transmit traffic to the destination station after being allocated a TXOP from the transmission station.

### <Protection of Relay Transmission>

As described above, when relay transmission is performed, the distance between the destination station and the AP may be relatively far, and thus relay transmission may be required. In this case, the NAV configuration states of the destination station and the AP may differ. For example, when the destination station completes the backoff procedure, the AP may have an NAV configured by a frame transmitted by a non-AP station different from the destination station, or the AP may be receiving a frame from another non-AP station. In addition, when the destination station completes the backoff procedure, the relay station may be in a situation where it is unable to receive the transmission of the destination station. Therefore, the relay station may not receive the transmission of the destination station, or the AP may not receive the transmission of the relay station. In addition, when the AP has completed the backoff procedure, a NAV may be configured by a frame transmitted by the non-AP station to the destination station, or the destination station may be receiving a frame from the non-AP station. Therefore, the relay station may not be able to receive at the time the AP completes the backoff procedure, or the destination station may not be able to receive at the time the relay station completes the backoff procedure. Therefore, a method for protecting frame exchange between the AP, the relay station, and the destination station may be required. In this case, an RTS (request to send) frame/CTS (clear to send) frame exchange may be performed to protect the frame exchange. In the disclosure, the RTS frame may be substituted with an MU-RTS frame unless otherwise specified. In another specific embodiment, a non-HT PPDU exchange may be performed to protect the frame exchange.

The destination station may perform RTS frame/CTS frame exchange between the destination station and the AP and RTS frame/CTS frame exchange between the destination station and the relay station. In another specific embodiment, the destination station may perform RTS frame/CTS frame exchange between the destination station and the relay station and RTS frame/CTS frame exchange between the destination station and the AP. Through this, the destination station may obtain a TXOP for performing uplink transmission relay, and may protect the uplink transmission relay from each of the hidden nodes of the destination station, the relay station, and the AP.

If either one of the two RTS frame/CTS frame exchanges fails, the destination station may be considered to have failed to obtain the TXOP. In this case, the destination station may perform an operation corresponding to a failure to obtain a TXOP. Specifically, the destination station may restart the backoff procedure. If the destination station successfully exchanges a first RTS frame/CTS frame and fails to exchange a second RTS frame/CTS frame, when the destination station attempts RTS frame/CTS frame exchange again, the destination station may perform a backoff procedure by using the minimum value of the contention window (CW). In addition, when the destination station successfully exchanges the first RTS frame/CTS frame and then fails to exchange the second RTS frame/CTS frame, the destination station may transmit a CF-End frame. In this case, the station having received the CF-End frame may transmit the CF-End frame. Through this embodiment, the NAV configured by RTS frame/CTS frame exchange may be released.

In addition, the AP may perform RTS frame/CTS frame exchange between the AP and the destination station and RTS frame/CTS frame exchange between the AP and the relay station. In another specific embodiment, the AP may perform RTS frame/CTS frame exchange between the AP and the relay station and RTS frame/CTS frame exchange between the AP and the destination station. This allows protection of the downlink transmission relay. When either of the two RTS frame/CTS frame exchanges fails, the AP may be considered to have failed to obtain the TXOP. In addition, in a specific embodiment, the AP may perform another frame exchange instead of the first RTS frame/CTS frame exchange. Specifically, the AP may perform MU-RTS frame/CTS frame exchange instead of the first RTS frame/CTS frame exchange. In this case, the MU-RTS frame may indicate a station other than the destination device as a destination station. In this embodiment, when the AP receives a CTS frame from one of the stations, the AP may determine that the MU-RTS frame/CTS frame has been successfully exchanged.

In addition, the AP may first perform transmission without using the relay station, such as DL PPDU transmission and TB PPDU reception, and then perform downlink transmission relay within the obtained TXOP. Therefore, the frame exchange protection between the AP and the relay station may already be in a configured state. In this case, the AP may perform a downlink transmission relay after exchanging the RTS frame and the CTS frame between the AP and the destination station.

The embodiments for protecting the uplink transmission relay or downlink transmission relay described above include two RTS frame/CTS frame exchanges. The need for two frame exchanges may reduce transmission efficiency and may be a burden to a station performing a protection operation. Therefore, a method that may protect relay transmission with one frame exchange may be required.

The transmission station, non-AP station, or AP may transmit a designated trigger frame to the destination station, AP, or non-AP station to protect relay transmission. For the convenience of description, the trigger frame defined to protect relay transmission is referred to as a relay RTS frame. The relay station and the destination station receiving the relay RTS frame may transmit a designated CTS frame to protect the relay transmission. For the convenience of description, the designated CTS frame to protect relay transmission is referred to as a relay CTS frame.

The relay station and the destination station may transmit the relay CTS frame by using different RUs or frequency tones, respectively. In this case, the transmission station may determine the station that has transmitted the Relay CTS frame through the RU or frequency tone in which the Relay CTS frame is received. The relay station and the destination station may transmit the payload of the relay CTS frame in different RUs or frequency tones, respectively. For example, the relay station may transmit the payload of the Relay CTS frame in the lower 10 MHz frequency band of the primary 20 MHz subchannel, and the destination station may transmit the payload of the Relay CTS frame in the higher 10 MHz frequency band of the primary 20 MHz subchannel. In addition, when the transmission station determines that the received Relay CTS frame has energy in the entire primary 20 MHz, the transmission station may determine that both the relay station and the destination station transmit the Relay CTS frame.

In another specific embodiment, the relay station and the destination station may transmit the Relay CTS frame at different times. The transmission station may determine the station that has transmitted the relay CTS frame based on the time at which the relay CTS frame is received. Specifically, the relay station and the destination station may transmit the Relay CTS frame in a predesignated order. The transmission station may determine the station that has transmitted the received relay CTS frame in a predesignated order. For example, the transmission station may determine that the first received Relay CTS frame is transmitted by the relay station, and determine that the second received Relay CTS frame is transmitted by the destination station. In a specific embodiment, the relay station may transmit the Relay CTS frame at short inter-frame space (SIFS) intervals with the Relay RTS frame, and the destination station may transmit the Relay CTS frame at 2×SIFS intervals with the Relay RTS frame. In this case, the transmission station may determine that the Relay CTS frame transmitted at SIFS intervals with the Relay RTS frame is transmitted by the relay station and the Relay CTS frame transmitted at 2×SIFS intervals with the Relay RTS frame is transmitted by the destination station. In the above-described embodiment, the relay CTS frame is transmitted at SIFS unit intervals. According to a specific embodiment, a time duration shorter than the SIFS may be used instead of the SIFS.

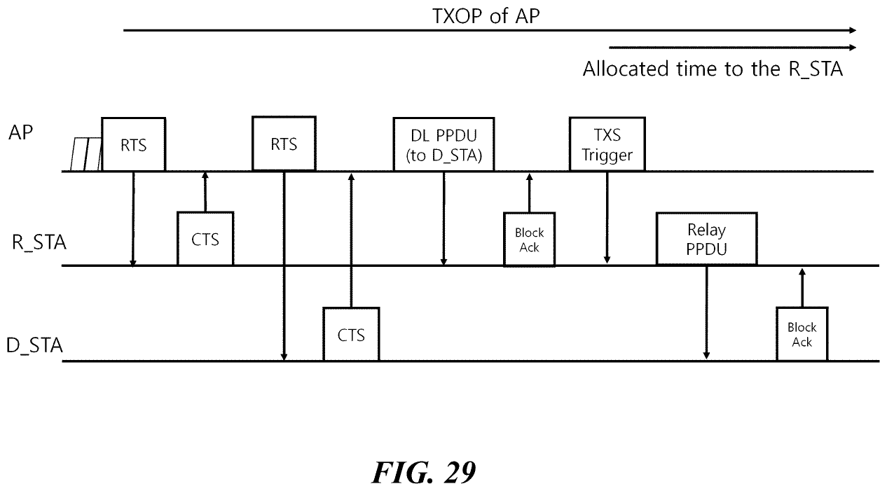

FIG. 29 illustrates an operation in which an AP performs two times of RTS frame/CTS frame exchanges to protect relay downlink transmission according to an embodiment of the disclosure.

The AP transmits an RTS frame to the relay station (R_STA). The relay station (R_STA) transmits a CTS frame to the AP in response to the RTS frame. In this case, the interval between the RTS frame and the CTS frame is SIFS. The AP receiving the CTS frame determines that the relay station (R_STA) is in a state capable of receiving the DL PPDU.

The AP transmits an RTS frame to the destination station (D_STA). The destination station (D_STA) transmits a CTS frame to the AP in response to the RTS frame. In this case, the interval between the RTS frame and the CTS frame is SIFS. The AP receiving the CTS frame determines that the destination station (D_STA) is in a state capable of receiving the relay PPDU.

The two RTS/CTS frame exchanges configure NAV for each of the neighboring stations of the AP, the relay station, and the destination station. This allows the downlink transmission relay to be protected.

The AP transmits, to the relay station (R_STA), a DL PPDU including traffic to be transmitted to the destination station. The relay station (R_STA) transmits a BlockAck to the AP. The AP may receive the BlockAck from the relay station (R_STA) and determine whether the traffic transmission is successful. When traffic transmission is successful, the AP allocates the TXOP obtained by the AP to the relay station (R_STA). Specifically, the AP allocates the obtained TXOP to the relay station (R_STA) by transmitting a TXS trigger frame (TXS Trigger) to the R_STA. As described above, in the embodiment of FIG. 29, the AP allocating the TXOP to the relay station (R_STA) may indicate that the relay PPDU transmission is about to start.

The relay station (R_STA) transmits the traffic received from the AP to the destination station (D_STA) as a relay PPDU. The destination station (D_STA) receives the relay PPDU. The destination station (D_STA) transmits, to the relay station (R_STA), a BlockAck indicating whether the MPDU included in the relay PPDU has been received.

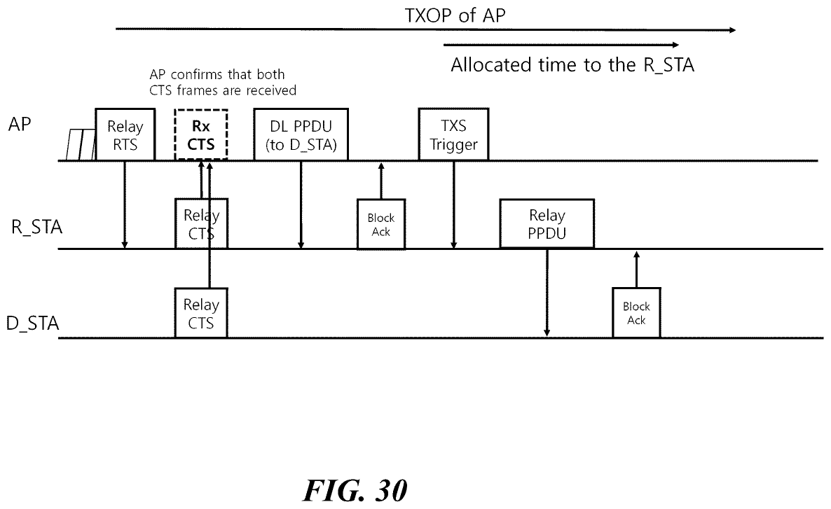

FIG. 30 illustrates an operation in which an AP performs one time of RTS frame/CTS frame exchange to protect relay downlink transmission according to an embodiment of the disclosure.

The same operations as those described in FIG. 29 are omitted. The AP transmits a Relay RTS frame. The relay station (R_STA) and the destination station (D_STA) transmit relay CTS frames in response to the relay RTS frame. This allows the AP to protect the downlink transmission relay. The AP receives the Relay CTS frame from the relay station (R_STA) and the destination station (D_STA), and then transmits a DL PPDU to the relay station (R_STA). As described above, if the AP does not receive a Relay CTS frame from either the relay station (R_STA) or the destination station (D_STA), the AP does not transmit a DL PPDU to the relay station (R_STA).

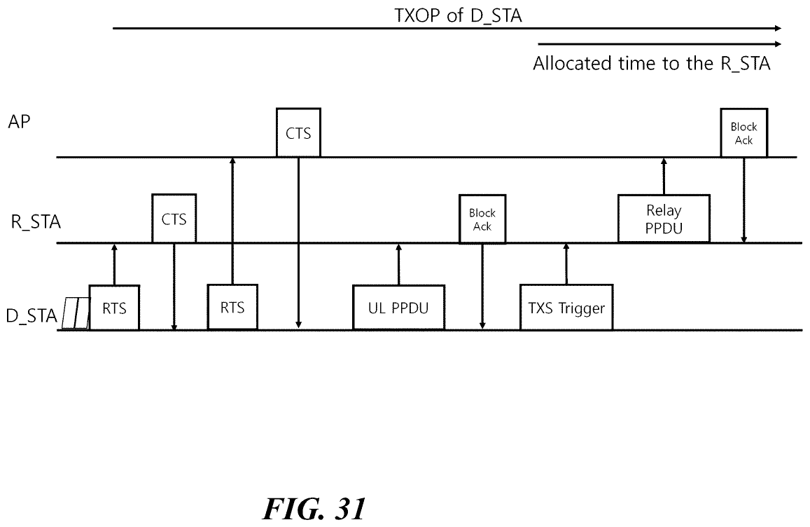

FIG. 31 illustrates an operation in which a non-AP station performs two times of RTS frame/CTS frame exchanges to protect uplink transmission relay according to an embodiment of the disclosure.

The destination station (D_STA) transmits an RTS frame to the relay station (R_STA). The relay station (R_STA) transmits a CTS frame to the destination station (D_STA) in response to the RTS frame. The destination station (D_STA) transmits an RTS frame to the AP. The AP transmits a CTS frame to the destination station (D_STA) in response to the RTS frame. Through this operation, the destination station (D_STA) may determine that the relay station (R_STA) is in a state capable of receiving a UL PPDU and the AP is in a state capable of receiving a relay PPDU.

The two RTS/CTS frame exchanges configure NAV for each of the neighboring stations of the AP, the relay station, and the destination station. This allows the uplink transmission relay to be protected.

The destination station (D_STA) transmits, to the relay station (R_STA), a UL PPDU including traffic to be transmitted to the AP. The relay station (R_STA) receives the UL PPDU. The relay station (R_STA) transmits, to the destination station (D_STA), a block ACK indicating whether the MPDU included in the UL PPDU has been received. When the transmission of traffic included in the UL PPDU is successful, the destination station (D_STA) allocates the TXOP obtained by the destination station (D_STA) to the relay station (R_STA).

When traffic transmission is successful, the destination station (D_STA) allocates the TXOP obtained by the AP to the relay station (R_STA). Specifically, the destination station (D_STA) transmits a TXS trigger frame (TXS Trigger) to the relay station (R_STA) to allocate the TXOP obtained by the destination station (D_STA). As described above, in the embodiment of FIG. 31, the destination station (D_STA) allocating the TXOP to the relay station (R_STA) may indicate that the relay PPDU transmission is about to start. In this case, the type of the TXS trigger frame may be designated to be a different type than the type of the TXS trigger frame transmitted by the AP. The relay station (R_STA) transmits traffic received from the destination station (D_STA) to the AP through the relay PPDU. The AP receives the relay PPDU and transmits a BlockAck to the relay station (R_STA).

### <Method for Designating Relay Station>

As described above, the AP may perform setup for a relay operation with a non-AP station. In this case, the non-AP STA may inform the AP that a relay operation is possible. Specifically, the multiple non-AP stations may perform coordination, and at least one of the non-AP stations may inform the AP that a relay operation is possible. In another specific embodiment, the AP may designate a specific non-AP station as a relay station. Through this, the AP may determine whether to transmit the MPDU directly to the corresponding non-AP station or transmit the MPDU through the relay station. To this end, the AP may perform an operation to find a non-AP station that supports a relay operation. The AP may determine a non-AP station that may perform a relay operation, based on information obtained when associating with a non-AP station or information obtained for a relay operation, for example, information obtained in a relay discovery process. When there are multiple non-AP stations that support a relay operation, a method for the AP to determine which non-AP station to designate as a relay station is required.

First, embodiments for determining whether the AP performs a relay operation are described.

When the signal strength of a signal received from a non-AP station among non-AP stations to which the AP is to transmit traffic is less than or equal to a predesignated value, the AP may transmit traffic to the corresponding non-AP station by using relay transmission. In another specific embodiment, when the number of transmissions performed with a predesignated data rate or higher to a non-AP station by the AP fails more than a predesignated number of times, the AP may transmit traffic to the non-AP station using relay transmission. In this case, the AP may transmit traffic to the non-AP station without using relay transmission by using a data rate less than a predesignated data rate. In another specific embodiment, the AP may determine whether to transmit a PPDU including traffic by relay transmission, based on a coding method of a PPDU including traffic. Specifically, when the AP attempts to transmit a PPDU including traffic with a data rate less than a predesignated data rate or an MCS less than a predesignated MCS, the AP may transmit the PPDU including the traffic with a data rate less than the predesignated data rate to the non-AP station without using relay transmission regardless of whether the relay station is present.

The AP may designate one of the multiple non-AP stations supporting relay operations as a relay station by using the following embodiments. For the convenience of description, a non-AP station that may be designated as one of multiple non-AP stations or relay stations supporting relay operations is referred to as a relay station candidate.

The AP may obtain information on multiple relay station candidates and designate one of the multiple relay station candidates as the relay station based on the obtained information. The information on the relay station candidate may include a signal sensitivity between the relay station and the AP.

A relay station discovery procedure is described. The AP may transmit a Relay Sounding Request frame indicating that the discovery procedure starts. The Relay Sounding Request frame may include information indicating a destination device that attempts to participate in relay transmission. The Relay Sounding Request frame may include information related to the AID or MAC address of the destination station that attempts to participate in relay transmission. In addition, the Relay Sounding Request frame may indicate a relay station candidate for receiving a measurement frame and performing reporting. The Relay Sounding Request frame may include information indicating a relay station candidate. In addition, the Relay Sounding Request frame may indicate information on a resource unit (RU) allocation that a relay station candidate uses when transmitting the measurement frame. When the destination station receives, from the AP, the Relay Sounding Request frame requesting transmission of the measurement frame of the destination station, the destination station may determine that the AP uses relay transmission for communication between the destination station and the AP. When the destination station receives the Relay Sounding Request frame requesting the transmission of the measurement frame of the destination station from the AP, the destination station may transmit UL traffic through the relay station. The destination station indicated by the Relay Sounding Request frame may receive the Relay Sounding Request frame and transmit the measurement frame after a predesignated time period. The predesignated time may be SIFS or PIFS. In addition, the measurement frame may be a frame that does not include a payload. Specifically, the measurement frame may be a null data PPDU (NDP). In a specific embodiment, the measurement frame may be replaced with a frame of another type other than the NDP frame.

A station that receives the Relay Sounding Request frame and is not indicated to transmit the measurement frame by the Relay Sounding Request frame may receive the measurement frame transmitted after the Relay Sounding Request frame and measure the received signal sensitivity of the measurement frame. The received signal sensitivity may include at least one of a received signal strength indicator (RSSI) and a signal to noise ratio (SNR). In addition, the station receiving the measurement frame may transmit a reporting frame including information related to the received signal sensitivity after a predesignated time period from the measurement frame reception. In this case, the predesignated time period is SIFS or PIFS. In addition, the reporting frame may include information on the received signal sensitivity of the Relay Sounding Request frame measured by the station. In addition, the station may transmit the reporting frame through the RU allocated to the station. In this case, the Relay Sounding Request frame may indicate an RU allocated to the station. In another specific embodiment, the trigger frame transmitted by the AP may indicate an RU allocated to the station.

The AP receiving the reporting frame may designate a relay station from among the multiple relay station candidates, based on at least one of the reception sensitivity for the measurement frame or the reception sensitivity for the relay sounding request frame. When the AP receives one reporting frame, the AP may designate the station that has transmitted the reporting frame as a relay station. Specifically, the AP receiving the reporting frame may designate a relay station among multiple relay station candidates, based on the reception sensitivity for the measurement frame or the reception sensitivity for the Relay Sounding Request frame. For example, even if the measurement frame reception sensitivity of a certain relay station candidate is better than the measurement frame reception sensitivity of other relay station candidates, the reception sensitivity of the Relay Sounding Request frame of the certain relay station candidate may not be better than the measurement frame reception sensitivity of the other relay station candidates. In this case, the AP may not designate the corresponding relay station candidate as the relay station.

After the relay station is designated, the AP and the destination station may exchange traffic through the relay station. In this case, the AP may attempt direct transmission to the destination station. Thereafter, the AP and the destination station may exchange traffic directly without performing relay transmission. Specifically, when the RA field of the MAC frame received by the destination station from the AP indicates the MAC address of the station, the destination station may determine that the transmission to the relay has been terminated.

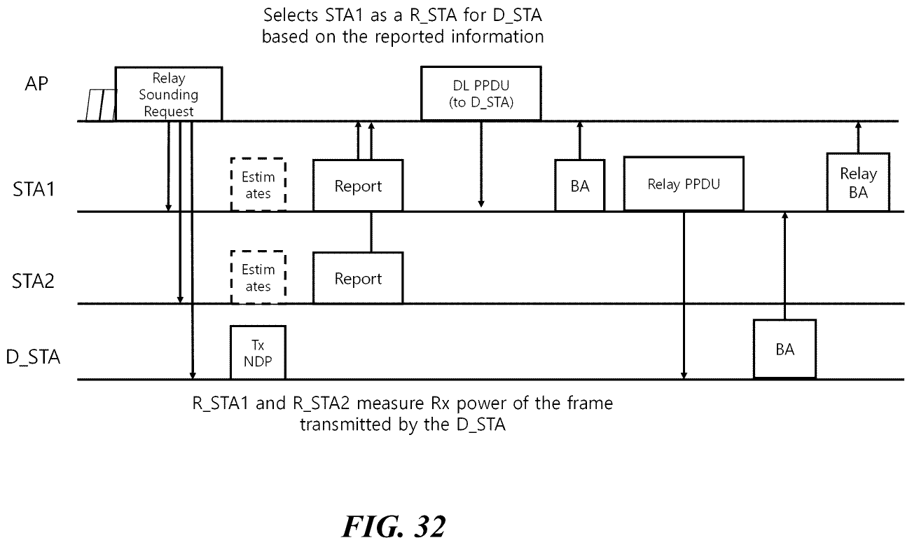

FIG. 32 illustrates an operation of an AP designating a relay station for a destination station according to an embodiment of the disclosure.

The AP transmits a Relay Sounding Request frame. The relay sounding request frame indicates the destination station (D_STA) to transmits a measurement frame (NDP). In addition, the Relay Sounding Request frame indicates the RU to which the first station (STA1) and the second station (STA2) transmit the reporting frame (Report).

The destination station (D_STA) receives the Relay Sounding Request frame and transmits the NDP frame at a predesignated time interval from the Relay Sounding Request frame. The predesignated time period may be SIFS or PIFS. The first station (STA1) and the second station (STA2) measure the reception sensitivity of the NDP frame. The first station (STA1) and the second station (STA2) transmit, to the AP, a reporting frame (Report) at a predesignated interval from the NDP frame. The reporting frame includes information on the reception sensitivity of the NDP frame. In addition, the reporting frame may further include information on the reception sensitivity of the Relay Sounding Request frame. STA1 and STA2 transmit a reporting frame (Report) to the AP in an RU allocated to each of STA1 and STA2 by the Relay Sounding Request frame.

The AP designates the first station (STA1) as a relay station (R_STA) based on the information obtained from the report frame (Report) received from the first station (STA1) and the second station (STA2). After designating the first station (STA1) as a relay station (R_STA), the AP transmits traffic, to the first station (STA1), to be transmitted to the destination station (D_STA). The first station (STA1) transmits a relay PPDU including the traffic received from the AP to the destination station (D_STA).

### <Correlation Between Relay Transmission and TWT Operation>

The relay station may perform a power-save operation. When the relay station maintains the doze state, relay transmission may be interrupted. Specifically, the relay station remains in the doze state during a TWT service period (SP) and remains in the awake state during a non-TWT SP. In the doze state, the relay station may not perform operations other than essential operations. For example, the relay station may not support transmission and reception operations in the doze state. Therefore, during the non-TWT SP, the relay station may not perform a relay operation. During the non-TWT SP, the relay station may not receive a downlink relay MPDU from the AP and may not transmit the downlink relay MPDU to the destination station. In addition, the relay station may not receive an uplink relay MPDU from the destination station and may not transmit the uplink relay MPDU to the AP. In this case, the downlink relay MPDU refers to an MPDU including traffic that the AP is to transmit to the destination station. In addition, the uplink relay MPDU refers to an MPDU including traffic that the destination station is to transmit to the AP. In addition, in the awake state, the relay station may support all operations. For example, the non-AP station in which 10 ms of the 100 ms time period is configured to TWT SP performs transmission and reception with the AP during the TWT SP. The non-AP station may remain in the doze state for 90 ms in the non-TWT SP. This allows the non-AP station to reduce power consumption.

The TWT SP may be configured through an individual TWT agreement or operated through a broadcast TWT operation. The individual TWT agreement may be established by a negotiation performed between two stations, for example, the AP and the non-AP station. When the individual TWT agreement is established, the non-AP station may transition to the doze state during a time period other than the TWT SP. In the broadcast TWT operation, the TWT scheduling AP schedules a TWT SP and indicates information related to the TWT SP through a broadcast TWT element included in a management frame, such as a beacon frame. The non-AP station that obtains the information on the broadcast TWT SP through the received broadcast TWT element may become a TWT scheduled station of the TWT SP by transmitting a TWT request frame to the TWT scheduling AP. In this case, the TWT scheduling AP is an AP for establishing a broadcast TWT, and the TWT scheduled station is a non-AP station that participates in the broadcast TWT SP and performs a power-save operation.

The relay station may also perform a power-save operation according to the TWT SP. Specifically, the time period during which the relay station may support relay transmission for the destination station may be the TWT SP of the relay station. As described above, during a period other than the TWT SP, the relay station may not perform a relay operation. During the period other than the TWT SP, the relay station may not receive a downlink relay MPDU from the AP and may not transmit a downlink relay MPDU to the destination station. In addition, the relay station may not receive an uplink relay MPDU from the destination station and may not transmit an uplink relay MPDU to the AP. The AP may determine whether the relay station is in the awake state, and when the relay station is in the awake state, the AP may transmit data to the destination station through the relay station. The destination station may change the power state according to the TWT SP in which the relay station participates. Specifically, when the relay station is in the doze state, the destination station may enter the doze state. This is because, when the relay station is in the doze state, the destination station cannot expect transmission and reception through the relay station. The destination station may enter the awake state when the relay station is in the awake state. Therefore, the TWT SP in which the relay station participates may be applied to the destination station as is.

When the AP establishes a TWT agreement with the relay station, the AP may signal information about the TWT agreement established with the relay station to the destination station. The destination station may change its power state based on the information on the TWT negotiation. In addition, the relay station may transmit information on the TWT agreement established between the AP and the relay station to the destination station.

In addition, the AP may operate a broadcast TWT SP. When the relay station is a member station of the broadcast TWT SP, the destination station may participate as a member station of the broadcast TWT SP of the relay station. In this case, the information on the broadcast TWT SP may be transmitted to the destination station by the AP or the relay station. In this case, the information of the broadcast TWT SP may be transmitted to the destination station through a frame including a TWT element. The information about the TWT SP may be transmitted through the TWT element with the TWT Setup Command field configured to 1 (Suggest TWT) or 2 (Demand TWT).

The destination station may participate in a TWT SP in which the relay station does not participate and perform additional power-save operation. The TWT SP of the relay station may be included in the TWT SP of the destination station. Specifically, the destination station may remain in the doze state even while the relay station remains in the awake state. The destination station may configure the TWT SP of the destination station based on the TWT SP of the relay station. Specifically, the destination station may configure a TWT SP that is the same as the TWT SP of the relay station.

The AP may transmit, to the relay station, an MPDU including traffic to be transmitted to the destination station only in the time period in which the AP expects the destination station to be in the awake state. When the relay station is in the awake state, for example, within the TWT SP period in which the relay station participates, or when the destination station is determined to be in the doze state even if the relay station is not performing a power-save operation, the AP may not be allowed to transmit traffic intended for the destination to the relay station. This is because the destination station cannot perform reception from the relay station when the destination station is in the doze state.

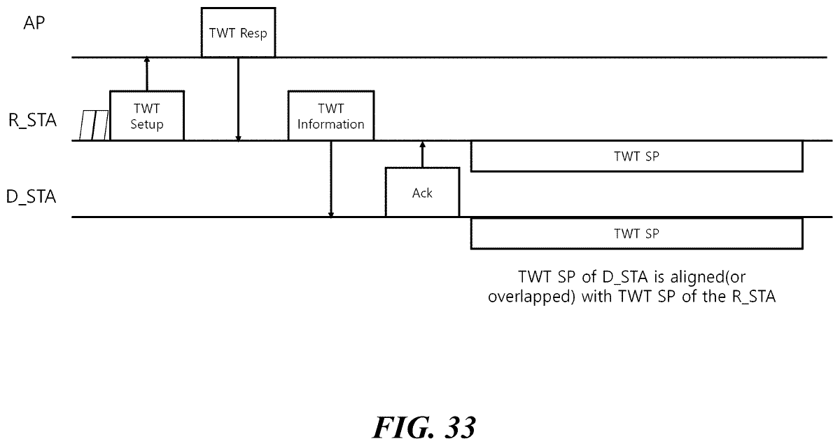

FIG. 33 illustrates an operation in which a TWT agreement established between a relay station and an AP is applied to a destination station according to an embodiment of the disclosure. In an embodiment of FIG. 33, the relay station and the AP exchange a TWT Setup frame and a TWT Response frame to establish a TWT agreement. Through this, the relay station transmits the TWT Setup frame requesting the establishment of an individual TWT agreement, and the AP accepts the individual TWT agreement. The TWT Setup frame is a frame including a TWT element with the TWT Request subfield configured to 1. The TWT Response frame is a frame including a TWT element with the TWT Request subfield configured to 0.

After an individual TWT agreement is established, the relay station transmits a frame (TWT Information) including information on the established TWT agreement to the destination station. The destination station having received the frame (TWT Information) transmits an ACK frame to the relay station. As described above, the destination station performs a power-save operation according to the TWT SP of the TWT agreement established between the relay station and the AP. In this case, the destination station may have the same TWT SP as the relay station.

### <Relay Service Period>

The relay station may configure a relay service period supporting relay transmission. The relay station may support relay transmission only in the relay service period and may not support relay transmission outside the relay service period. This is because the relay transmission performed by the relay station is an operation for another non-AP station and the AP, not an operation for the relay station, and the excessive relay operation may impose a burden on the processing and power efficiency of the relay station.

A station supporting a relay operation may transmit information on capability related to the relay operation to the AP. In this case, the information on the capability related to the relay operation may include a relay service period. The information on the capability related to the relay operation may include information on the maximum frequency bandwidth (BW) supported when the station transmits/receives a relay PPDU. The information on the capability related to the relay operation may include information on whether the station supports transmitting and receiving Multi-TID A-MPDUs for the relay operation. The information on the capability related to the relay operation may include information on the maximum transmission output that the station may use when transmitting the relay PPDU. An element including information on the capability related to the relay operation operations is referred to as a Relay Support element.

When a station supporting a relay operation is associated with the AP, the station may transmit the Relay Support element to the AP. Specifically, the station may transmit an Association Request frame including the Relay Support element to an AP. In addition, when the station receives the Relay Request frame from the AP, the station may transmit the Relay Support element to the AP. In addition, the relay station may transmit the Relay Support element to the destination station through a first relay PPDU. In another specific embodiment, the relay station may transmit the Relay Support element to the destination station by using a separate PPDU before transmitting the first relay PPDU to the destination station. The AP and the destination station may perform a relay operation according to the most recently received Relay Support element from the relay station.

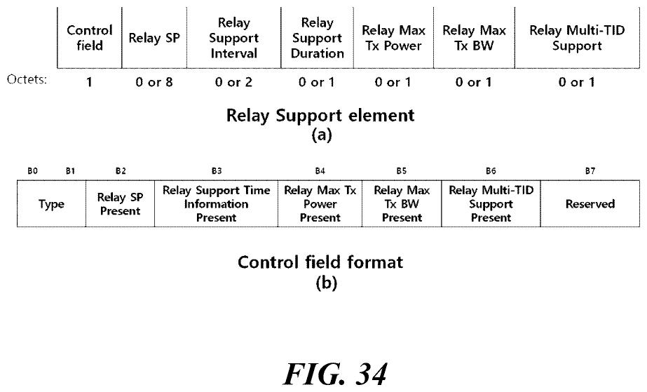

FIG. 34 illustrates a Relay Support element according to an embodiment of the disclosure.

The Relay Support element may include at least one of a Control field, a Relay Support Interval field, a Relay Support Duration field, a Relay Max Tx Power field, a Relay Max Tx Bandwidth (BW) field, and a Relay Multi-TID Support field.

The Control field of the Relay Support element has a size of 1 octet and may indicate the type of the relay operation supported by the station that has transmitted the Relay Support element and whether fields that may be included in the Relay Support element are included.

A Type subfield may indicate the type of the relay operation supported by the station that has transmitted the Relay Support element. When the value of the Type subfield is 0, the Type subfield may indicate that the station that has transmitted the Relay Support element supports single TXOP relay operation. The single TXOP relay operation is an operation in which a relay station receives traffic for relay transmission in a single TXOP from the AP or the destination station, and transmits a relay PPDU to the destination station or the AP in the corresponding TXOP. When the value of the Type subfield is 0, the Type subfield may indicate that the station that has transmitted the Relay Support element supports a separate TXOP relay operation. The individual TXOP relay operation is an operation of receiving relay traffic in the first TXOP from the AP or the destination station and transmitting a relay PPDU by using the second TXOP. Therefore, in the individual TXOP relay operation, the TXOP for receiving relay traffic by the relay station and the TXOP for transmitting relay PPDU by the relay station are distinguished. The values 2 and 3 of the Type subfield are reserved values.

A Relay SP Present subfield may indicate whether a Relay SP field is included in the Relay Support element. When the value of the Relay SP Present subfield is 1, the Relay Support element includes the Relay SP field. When the value of the Relay SP Present subfield is 0, the Relay support element does not include the Relay SP field. The value of the Relay SP Present subfield in the Relay support element included in the Association Request frame may always be configured to 0. In this case, the Relay Support element included in the Association Request frame does not include the Relay SP field.

The Relay SP field included in the Relay Support element may indicate information on the starting time point of the next relay service period that the station transmitting the Relay Support element may operate. Specifically, the Relay SP field may indicate the TSF of the starting time point of the next relay service period that the station transmitting the Relay Support element may operate. The destination station or the AP receiving the Relay Support element may attempt communication for relay transmission after the starting time point of the relay service period indicated by the Relay SP field.

A Relay Support Time Information Present subfield may indicate whether the Relay Support element includes the Relay Support Interval field and the Relay Support Duration field. When the value of the Relay Support Time Information Present subfield is 1, the Relay Support element includes the Relay Support Interval field and the Relay Support Duration field. When the value of the Relay Support Time Information Present subfield is 0, the Relay Support element does not include the Relay Support Interval field and the Relay Support Duration field. When the value of the Relay Support Time Information Present subfield is 0, the station transmitting the Relay Support element does not operate the relay service period and may always support the relay operation. Specifically, not defining a separate relay service period means that all time periods may be interpreted as relay service periods.

The Relay Support Interval field indicates an expected average time interval between two consecutive relay service periods. The relay service period described above is a time period in which the station supports the relay operation. The Relay Support Interval field may be a field having a size of 1-octet or 2-octet. The unit of the time value indicated by the Relay Support Interval field may be the same as the TWT Wake Interval Mantissa field of the TWT element.

The Relay Support Duration field may indicate the maximum time length of each relay service period. When the Relay Support Duration field indicates a specific time value, the maximum time length of the initiated relay service period may be maintained for a time equal to or shorter than the specific time value. In this case, the maximum time indicated by the Relay Support Duration field may be shorter than or equal to the time indicated by the Relay Support Interval field.

A transmission device for relay transmission, such as the AP or the destination station, for which a relay service period is designated based on the Relay Support Interval field and the Relay Support Duration field, may perform relay transmission according to the relay service period of the relay station. Specifically, the transmission device may transmit an MPDU (PPDU) for the destination device to the relay station only within the relay service period of the relay station. In addition, the transmission device may adjust the length of the PPDU transmitted by the transmission device so that the relay PPDU transmitted by the relay station is completed within the relay service period. The relay station may determine that the amount of traffic received from the transmission device is not possible to be transmitted to the destination device within the remaining relay service period. In this case, the relay station may not transmit the relay PPDU. In addition, the relay station may respond to the transmission device that the received traffic has not been transmitted due to the shortage of the remaining relay service period.

A Relay Max Tx Power Present service field may indicate whether the Relay Max Tx Power field is included in the Relay Support element. When the value of the Relay Max Tx Power Present subfield is 1, the Relay Support element includes the Relay Max Tx Power field. When the value of the Relay Max Tx Power Present subfield is 0, the Relay Support element does not include the Relay Max Tx Power field.

The Relay Max Tx Power field may indicate information on the maximum transmission power that the station transmitting the Relay Support element may use when transmitting a relay PPDU. Specifically, the relay station may transmit the relay PPDU with a value equal to or less than the value indicated by the Relay Max Tx Power field. In addition, the maximum transmit power of the UL PPDU transmitted by the relay station to the AP and the maximum transmit power of the relay PPDU transmitted to the destination station may be different.

A Relay Max Tx BW Present subfield indicates whether the Relay Max Tx BW field is included in the Relay Support element. When the value of the Relay Max Tx BW Present subfield is 1, the Relay Support element includes the Relay Max Tx BW field. When the value of the Relay Max Tx BW Present subfield is 0, the Relay Support element does not include the Relay Max Tx BW field.

The Relay Max Tx BW field indicates the maximum bandwidth (BW) that the station transmitting the Relay Support element supports when transmitting/receiving a relay PPDU. When the value of the Relay Max Tx BW field is 0, the maximum PPDU frequency bandwidth supported by the station transmitting the Relay Support element through relay transmission is 20 MHz. When the value of the Relay Max Tx BW field is 1, the maximum PPDU frequency bandwidth supported by the station transmitting the Relay Support element through relay transmission is 40 MHz. When the value of the Relay Max Tx BW field is 2, the maximum PPDU frequency bandwidth supported by the station transmitting the Relay Support element through relay transmission is 80 MHz. Therefore, the transmission device may determine the frequency bandwidth of the PPDU transmitted to the relay station according to the maximum frequency bandwidth supported by the relay station. Specifically, the transmission device may determine the frequency bandwidth of the PPDU to be transmitted to the relay station so that the frequency bandwidth is equal to or less than the maximum frequency bandwidth supported by the relay station.

A Relay Multi-TID Support Present subfield may indicate whether the Relay Support element includes the Relay Multi-TID Support field. When the value of the Relay Multi-TID Support Present subfield is 1, the Relay Support element includes the Relay Multi-TID Support field. When the value of the Relay Multi-TID Support Present subfield is 0, the Relay Support element does not include the Relay Multi-TID Support field.

The Relay Multi-TID Support field may indicate whether the station transmitting the Relay Support element supports Multi-TID A-MPDU transmission and reception for a relay operation. When the value of the Relay Multi-TID Support field is 0, the Relay Multi-TID Support field may indicate that the station transmitting the Relay Support element does not support Multi-TID A-MPDU in the relay operation. In this case, the transmission device, for example, the AP or the destination station, may configure an A-MPDU transmitted and received in relay transmission as a single TID A-MPDU. When the value of the Relay Multi-TID Support field is 1, the Relay Multi-TID Support field may indicate that the station transmitting the Relay Support element supports Multi-TID A-MPDU in the relay operation. In this case, the transmission device, for example, the AP or the destination station, may configure an A-MPDU transmitted and received in relay transmission as a Multi-TID A-MDPU. In addition, the value of the Relay Multi-TID Support field may indicate the number of maximum TIDs that the relay station may support in the A-MPDU minus 1. For example, when the value of the Relay Multi-TID Support field is 3, the Relay Support element may indicate that the station transmitting the Relay Support element supports an A-MPDU having four TIDs in the relay operation.

As described above, the relay station may support the relay operation only in the time period selected by the relay station. To this end, the relay station may operate a relay service period. The AP and destination station attempting to perform the relay operation with the relay station must attempt the relay operation according to a relay service period. Specifically, the AP and destination station attempting to perform the relay operation with the relay station may transmit relay traffic to the relay station only in the relay service period. In this case, the AP and destination station attempting to perform the relay operation with the relay station may defer transmission of relay traffic during times outside of the relay station's relay service period even if channel access has been completed. In addition, the AP and the destination station may restart the backoff procedure to defer the transmission. In this case, the size of the contention window, CW[AC] and the QoS station retry counter, and QSRC[AC] are maintained as is. This is because it does not restart the backoff procedure according to the transmission failure.

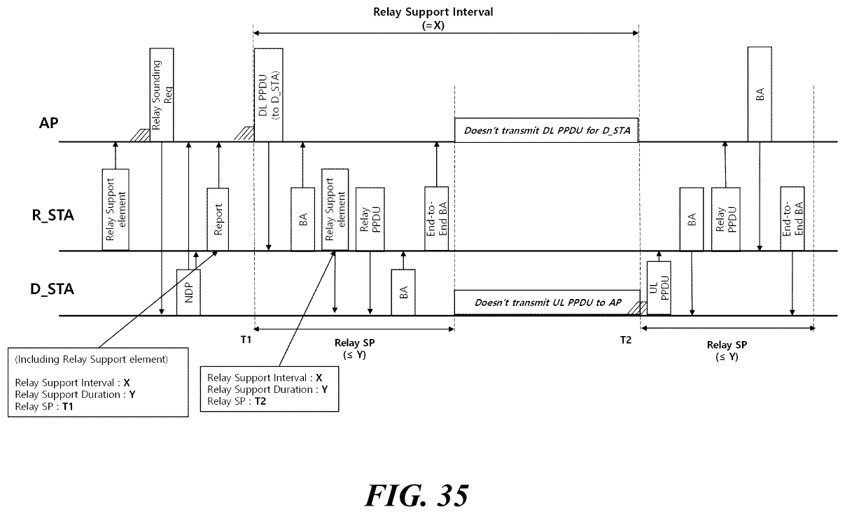

FIG. 35 illustrates a relay operation performed based on a relay service period indicated by a relay station according to an embodiment of the disclosure.

As described above, the relay station may transmit information on the capability related to the relay operation of the relay station when transmitting the reporting frame to the AP. In addition, the relay station may transmit information on the capability related to the relay operation to the destination station through a relay PPDU that is transmitted first in the relay transmission. The information on the capability related to the relay operation may be the above-described Relay Support element. In an embodiment of FIG. 35, the relay station (R_STA) transmits a Relay Support element to the AP through a reporting frame (Report) and transmits a Relay Support element to the destination station (D_STA) through a first relay PPDU. The value of the Relay Support Interval field in the Relay Support element is X, and the value of the Relay Support Duration field is Y. The value of the Relay SP field in the Relay Support element transmitted to the AP is T1, and the value of the Relay SP field in the Relay Support element transmitted to the destination station (D_STA) is T2.

The AP and the destination station (D_STA) determine a relay service period (Relay SP) of the relay station (R_STA) based on the value of the Relay SP field and the value of the Relay Support Duration field. The AP transmits a DL PPDU to the relay station (R_STA) within a relay service period (Relay SP) of the relay station (R_STA). The relay station (R_STA) receives the DL PPDU and responds to the AP with a block ACK frame (BA). The relay station (R_STA) transmits a relay PPDU including the Relay Support element to the destination station (D_STA). The destination station (D_STA) receives the relay PPDU and transmits a BlockAck frame (BA) to the relay station (R_STA). The relay station (R_STA) receives the BlockAck frame (BA) from the destination station (D_STA) and transmits, to the AP, information (End-to-End BA) indicating whether the transmission to the destination station is successful.

The operation of the relay station (R_STA) performing relay transmission is within the relay service period (Relay SP). Specifically, the time at which the AP transmits a DL PPDU to the relay station (R_STA) and the time at which the relay station (R_STA) transmits information (End-to-End BA) indicating whether the transmission to the destination station is successful to the AP are within the relay service period (Relay SP). Specifically, the time when the AP transmits the DL PPDU to the relay station (R_STA) is after T1, and the time when the AP transmits information (End-to-End BA) indicating whether the transmission to the destination station is successful is before a time Y has elapsed from T1.

The AP and the destination station (D_STA) do not perform transmission for the relay operation to the relay station (R_STA) during time periods other than the relay service period (Relay SP) of the relay station (R_STA).

After T2, the destination station (D_STA) transmits a UL PPDU to the relay station (R_STA). The relay station (R_STA) receives the UL PPDU and transmits a block ACK frame (BA) to the destination station (D_STA). The relay station (R_STA) transmits a relay PPDU to the AP. The AP receives the relay PPDU and transmits a BlockAck frame (BA) to the relay station (R_STA). The relay station (R_STA) transmits, to the destination station (D_STA), information (end-to-end BA) indicating whether the transmission to the AP is successful. In this case, the time when the destination station (D_STA) transmits the UL PPDU to the relay station (R_STA) is after T2, and the time when the destination station (D_STA) transmits information (End-to-End BA) indicating whether the transmission to the AP is successful is before a time of Y has elapsed from T2.

Although the disclosure has been described with reference to the example of wireless LAN communication, the disclosure is not limited thereto and may be equally applied to other communication systems such as cellular communication. In addition, the methods, devices, and systems of the disclosure have been described in relation to specific embodiments, but some or all of the components and operations of the disclosure may be implemented by using a computer system having a general-purpose hardware architecture.

The features, structures, and effects described in the embodiments above are included in at least one embodiment of the disclosure, and are not necessarily limited to only one embodiment. In addition, the features, structures, and effects exemplified in each embodiment may be combined or modified by a person having ordinary knowledge in the art to which the embodiments belong, and implemented in other embodiments. Therefore, the contents related to these combinations and modifications should be interpreted as being included within the scope of the disclosure.

The above description has been made in the context of embodiments, but this is merely illustrative and not intended to limit the invention, and those having ordinary skill in the art to which the disclosure pertains would recognize that various modifications and applications not illustrated above are possible without departing from the essential features of the embodiments. For example, each element specifically shown in the embodiment may be modified and implemented. In addition, the differences associated with these modifications and applications are to be interpreted as being included in the scope of the disclosure as defined in the appended claims.

1-24. (canceled)

25. A second station relaying information exchange between a first station and a third station, the second station comprising: a transceiver; and a processor, wherein the processor is configured to: transmit, to the third station, information on a critical update of the first station when an update corresponding to the critical update occurs in the first station.

26. The second station of claim 25, wherein the critical update is a change in an operating channel of a BSS operated by the first station.

27. The second station of claim 26, wherein the processor is configured to: receive, from the first station, a Channel Switch Announcement element indicating that the operating channel of the BSS operated by the first station is changed; and transmit, to the third station, information on the change in the operating channel of the BSS operated by the first station.

28. The second station of claim 25, wherein the first station and the second station are included together in a pre-formed set.

29. The second station of claim 25, wherein the processor is configured to: receive, from the third station, a first request frame requesting information delivery to the first station; transmit a first response frame to the first request frame when accepting the request for the information delivery; and receive, from the third station, a frame requesting initiation of the information delivery.

30. The second station of claim 29, wherein the third station transmits the first request frame based on a received signal strength measured by the third station.

31. The method of operating a second station relaying information exchange between a first station and a third station, the method comprising:
transmitting, to the third station, information on a critical update of the first station when an update corresponding to the critical update occurs in the first station.

32. The method of claim 31, wherein the critical update is a change in an operating channel of a BSS operated by the first station.

33. The method of claim 32, wherein the method further comprises receiving, from the first station, a Channel Switch Announcement element indicating that the operating channel of the BSS operated by the first station is changed; and transmitting, to the third station, information on the change in the operating channel of the BSS operated by the first station.

34. The method of claim 31, wherein the first station and the second station are included together in a pre-formed set.

35. The method of claim 31, wherein the method further comprises receiving, from the third station, a first request frame requesting information delivery to the first station; transmitting a first response frame to the first request frame when accepting the request for the information delivery; and receive, from the third station, a frame requesting initiation of the information delivery.

36. The second station of claim 35, wherein the third station transmits the first request frame based on a received signal strength measured by the third station.
